(19) United States
(12) Patent Application Publication
(10) Pub. No.: US 2012/0256974 A1
(43) Pub. Date: Oct. 11, 2012

(54) LIGHT SOURCE DEVICE, DISPLAY, AND ELECTRONIC UNIT

(75) Inventor: Masaru Minami, Kanagawa (JP)

(73) Assignee: Sony Corporation, Tokyo (JP)

(21) Appl. No.: 13/435,288

(22) Filed: Mar. 30, 2012

(30) Foreign Application Priority Data
Apr. 6, 2011 (JP) 2011-084733
Sep. 29, 2011 (JP) 2011-214870

(51) Int. Cl. G09G 5/10; F21V 13/12; G09F 13/18

(52) U.S. Cl. 345/690; 362/602; 362/609

(57) ABSTRACT

A display includes: a display section performing image display; and a light source device including a light guide plate and one or more first light sources, and emitting light for the image display, the light guide plate having a first internal reflection face and a second internal reflection face and having one or more side faces, and the first light sources being disposed to face the respective side faces of the light guide plate and to apply first illumination light. One or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.

### BACKGROUND

The present disclosure relates to a light source device and a display, and an electronic unit which realize stereoscopic viewing using a parallax barrier system.

As one of the stereoscopic display systems which do not necessitate special eyeglasses and allow stereoscopic viewing with naked eyes, there is known a stereoscopic display using a parallax barrier system. In such a stereoscopic display, a parallax barrier is disposed to face the front face (display face side) of a two-dimensional display panel. Typically, the parallax barrier has a structure in which a blocking part for blocking display image light from the two-dimensional display panel and an opening part (slit part) having a striped shape for allowing display image light to pass therethrough are alternately provided in a horizontal direction.

According to the parallax barrier system, parallax images for stereoscopic viewing (in the case of two perspectives, an perspective image for right eye and an perspective image left eye) are spatially divided and displayed on a two-dimensional display panel, and the parallax images are subjected to parallax separation in a horizontal direction by a parallax barrier to carry out stereoscopic viewing. By appropriately setting the slit width and the like of the parallax barrier, in the case where a viewer views the stereoscopic display from a predetermined position and direction, it is possible to allow different kinds of light of parallax images to respectively enter left and right eyes of the viewer through the slit part.

It is to be noted that, in the case where, for example, a transmission type liquid crystal display panel is used as a two-dimensional display panel, a configuration in which a parallax barrier is disposed on the back side of the two-dimensional display panel is possible (see Japanese Patent No. 3565391 (FIG. 10) and Japanese Unexamined Patent Application Publication No. 2007-187823 (FIG. 3)). In this case, the parallax barrier is disposed between the transmission type liquid crystal display panel and a backlight.

### SUMMARY

However, the stereoscopic display using the parallax barrier system necessitates a dedicated component, that is, the parallax barrier for three-dimensional display, and therefore necessitates more number of components and installation space than typical displays for two-dimensional display.

It is desirable to provide a light source device and a display, and an electronic unit which realize a function equivalent to a parallax barrier with use of a light guide plate.

A light source device of an embodiment of the present disclosure includes a light guide plate having a first internal reflection face and a second internal reflection face which face each other, and having one or more side faces; and one or more first light sources disposed to face the respective side faces of the light guide plate and to apply first illumination light through the side faces of the light guide plate into the light guide plate. One or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.

A display of an embodiment of the present disclosure includes a display section performing image display; and a light source device including a light guide plate and one or more first light sources, and emitting light for the image display toward the display section, the light guide plate having a first internal reflection face and a second internal reflection face which face each other and having one or more side faces, and the first light sources being disposed to face the respective side faces of the light guide plate and to apply first illumination light through the side face of the light guide plate into the light guide plate. One or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.

An electronic unit of an embodiment of the present disclosure includes a display. The display includes a display section performing an image display; and a light source device including a light guide plate and one or more first light sources, and emitting light for the image display toward the display section, the light guide plate having a first internal reflection face and a second internal reflection face which face each other and having one or more side faces, and the first light sources being disposed to face the respective side faces of the light guide plate, and to apply first illumination light through the side face of the light guide plate into the light guide plate. One or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.

In the light source device, display or electronic unit of the embodiment of the present disclosure, the first illumination light from the first light source is scattered by the scattering region, and a part or all of the light is emitted from the first internal reflection face to the outside of the light guide plate. Thus, it is possible to allow the light guide plate itself to have a function as a parallax barrier. In other words, it is possible to allow the light guide plate itself to, equivalently, function as a parallax barrier in which the scattering region serves as an opening part (slit part). In addition, since the plurality of scattering regions is varied in the form according to the distance from the predetermined side, the luminance distribution of light emitted to the outside of the light guide plate may be optimized.

With the light source device, display or electronic unit of the embodiment of the present disclosure, the scattering region is provided on the first internal reflection face or the second internal reflection face of the light guide plate, it is possible to allow the light guide plate itself to, equivalently, function as a parallax barrier. In addition, since the plurality of scattering regions is varied in the form according to the distance from the predetermined side, it is possible to optimize the luminance distribution of light emitted to the outside of the light guide plate.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a sectional view illustrating an exemplary configuration of a display according to a first embodiment of the present disclosure, and an emitting state of light rays from a light source device in the case where only a first light source is set to an on (light-on) state.

FIG. 2 is a sectional view illustrating an exemplary configuration of the display illustrated in FIG. 1, and an emitting state of light rays from the light source device in the case where only a second light source is set to an on (light-on) state.

FIG. 3 is a sectional view illustrating an exemplary configuration of the display illustrated in FIG. 1, and an emitting state of light rays from the light source device in the case where both of the first light source and the second light source are set to an on (light-on) state.

FIG. 4 is a sectional view illustrating a first modification of the display illustrated in FIG. 1.

FIG. 5 is a sectional view illustrating a second modification of the display illustrated in FIG. 1.

FIG. 6A is a sectional view illustrating a first exemplary configuration of a surface of a light guide plate of the display illustrated in FIG. 1, and FIG. 6B is an explanatory diagram schematically illustrating a scattering-reflection mode of light rays on the surface of the light guide plate illustrated in FIG. 6A.

FIG. 7A is a sectional view illustrating a second exemplary configuration of the surface of the light guide plate of the display illustrated in FIG. 1, and FIG. 7B is an explanatory diagram schematically illustrating a scattering-reflection mode of light rays on the surface of the light guide plate illustrated in FIG. 7A.

FIG. 8A is a sectional view illustrating a third exemplary configuration of the surface of the light guide plate of the display illustrated in FIG. 1, and FIG. 8B is an explanatory diagram schematically illustrating a scattering-reflection mode of light rays on the surface of the light guide plate illustrated in FIG. 8A.

FIG. 9 is a plan view illustrating an example of a pixel structure of a display section.

(A) of FIG. 10 is a plan view illustrating a first exemplary correspondence relationship between an allocation pattern in which two perspective images are allocated and a layout pattern of a scattering region in the pixel structure of FIG. 9, and (B) of FIG. 10 is a sectional view thereof.

FIG. 11 is an explanatory diagram illustrating luminance distributions in a Y direction and a X direction in the case where, in the light source device illustrated in FIG. 1, the first light sources are oppositely disposed on a first side and a second side of the light guide plate in the Y direction.

FIG. 12 is an explanatory diagram illustrating luminance distributions in the Y direction and the X direction in the case where, in the light source device illustrated in FIG. 1, the first light sources are oppositely disposed on a third side and a fourth side of the light guide plate in the X direction.

FIG. 13 is an explanatory diagram illustrating a first exemplary case where the structure (height) of the scattering region is changed to improve the luminance distribution in the case of FIG. 11.

FIG. 14 is an explanatory diagram illustrating a second exemplary case where the structure (height) of the scattering region is changed to improve the luminance distribution in the case of FIG. 11.

FIG. 15 is an explanatory diagram illustrating a third exemplary case where the structure (height) of the scattering region is changed to improve the luminance distribution in the case of FIG. 11.

FIG. 16 is a characteristic diagram illustrating measured differences in a luminance distribution resulting from differences in the structure (depth distribution) of the scattering region.

FIG. 17 is an explanatory diagram illustrating luminance distributions in the Y direction and the X direction, in the case where the first light sources are oppositely disposed on the first side and the second side of the light guide plate in the Y direction, in the light source device illustrated in FIG. 1.

FIG. 18 is an explanatory diagram illustrating luminance distributions in the Y direction and the X direction, in the case where the first light sources are oppositely disposed on the third side and the fourth side of the light guide plate in the X direction, in the light source device illustrated in FIG. 1.

FIG. 19 is an explanatory diagram illustrating an exemplary case where the structure (length) of the scattering region is changed to improve the luminance distribution in the case of FIG. 17.

FIG. 20 is an explanatory diagram illustrating an exemplary case where the structure (length) of the scattering region is changed to improve the luminance distribution in the case of FIG. 18.

FIG. 21 is an explanatory diagram illustrating a second exemplary correspondence relationship between the allocation pattern of perspective images and the layout pattern of the scattering region, and the luminance distribution thereof.

FIGS. 22A and 22B are sectional views illustrating an exemplary configuration of a display according to a second embodiment and an emitting state of light rays from a light source device; FIG. 22A illustrates light rays emitting state at the time of three-dimensional display, and FIG. 22B illustrates light rays emitting state at the time of two-dimensional display.

FIG. 23A is a sectional view illustrating a first exemplary configuration of a surface of a light guide plate of a display illustrated in FIGS. 22A and 22B, and FIG. 23B is an explanatory diagram schematically illustrating a scattering-reflection mode of light rays on the surface of the light guide plate illustrated in FIG. 23A.

FIG. 24A is a sectional view illustrating a second exemplary configuration of the surface of the light guide plate of the display illustrated in FIGS. 22A and 22B, and FIG. 24B is an explanatory diagram schematically illustrating a scattering-reflection mode of light rays on the surface of the light guide plate illustrated in FIG. 24A.

FIG. 25A is a sectional view illustrating a third exemplary configuration of the surface of the light guide plate of the display illustrated in FIGS. 22A and 22B, and FIG. 25B is an explanatory diagram schematically illustrating a scattering-reflection mode of light rays on the surface of the light guide plate illustrated in FIG. 25A.

(A) of FIG. 26 is a plan view illustrating an exemplary correspondence relationship between an allocation pattern in which two perspective images are allocated and a layout pattern of a scattering region in the display of FIGS. 22A and 22B, and (B) of FIG. 26 is a sectional view thereof.

FIGS. 27A and 27B are sectional views illustrating an exemplary configuration of a display according to a third embodiment and an emitting state of light rays from a light source device; FIG. 27A illustrates an emitting state of light rays at the time of three-dimensional display, and FIG. 27B illustrates an emitting state of light rays at the time of two-dimensional display.

FIGS. 28A and 28B are sectional views illustrating an exemplary configuration of a display according to a fourth embodiment and an emitting state of light rays from a light source device; FIG. 28A illustrates an emitting state of light rays at the time of three-dimensional display, and FIG. 28B illustrates an emitting state of light rays at the time of two-dimensional display.

FIG. 29 is an external appearance view illustrating an exemplary electronic unit.

### DETAILED DESCRIPTION

Below, embodiments of the present disclosure are described in detail with reference to the figures.

### First Embodiment

### General Configuration of Display

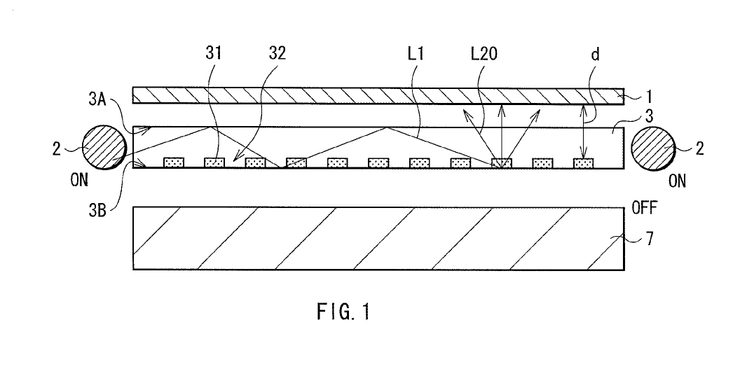

FIG. 1 to FIG. 3 illustrate exemplary configurations of a display according to a first embodiment of the present disclosure. The display includes a display section 1 for performing an image display, and a light source device which is disposed on the back side of the display section 1 and intended to emit light for image display toward the display section 1. The light source device includes first light sources 2 (light sources for 2D/3D display), a light guide plate 3, and a second light source 7 (light source for 2D display). The light guide plate 3 has a first internal reflection face 3A oppositely placed on the display section 1 side, and a second internal reflection face 3B oppositely placed on the second light source 7 side. It is to be noted that, while the display includes other components such as a control circuit for the display section 1 necessary for displaying, since the configuration thereof is similar to that of typical display control circuits and the like, the description thereof is omitted. In addition, although not shown in the figures, the light source device includes a control circuit for performing on (light-on)/off (light-off) control of the first light sources 2 and the second light source 7.

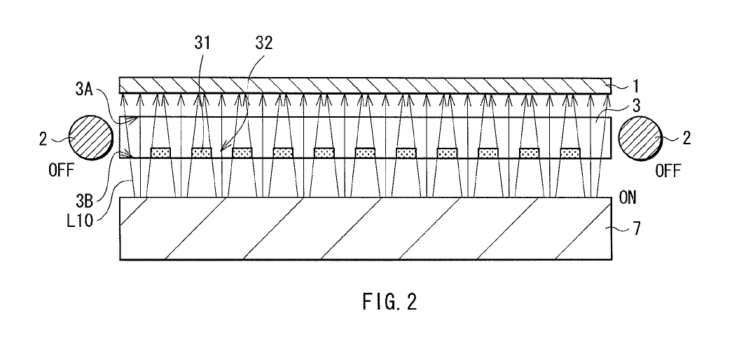

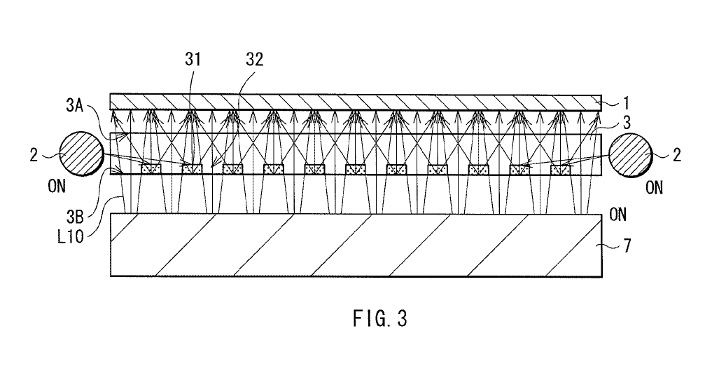

The display is capable of arbitrarily and selectively switching modes between a two-dimensional (2D) display mode over the entire screen and a three-dimensional (3D) display mode over the entire screen. The switching modes between the two-dimensional display mode and the three-dimensional display mode is made possible by performing a switching control of image data displayed on the display section 1, and a switching control of on/off of the first light sources 2 and the second light source 7. FIG. 1 schematically illustrates an emitting state of light rays from the light source device in the case where only the first light sources 2 are set to an on (light-on) state, and this corresponds to the three-dimensional display mode. FIG. 2 schematically illustrates an emitting state of light rays from the light source device in the case where only the second light source 7 is set to an on (light-on) state, and this corresponds to the two-dimensional display mode. In addition, FIG. 3 schematically illustrates an emitting state of light rays from the light source device in the case where both of the first light sources 2 and the second light source 7 are set to an on (light-on) state, and this also corresponds to the two-dimensional display mode.

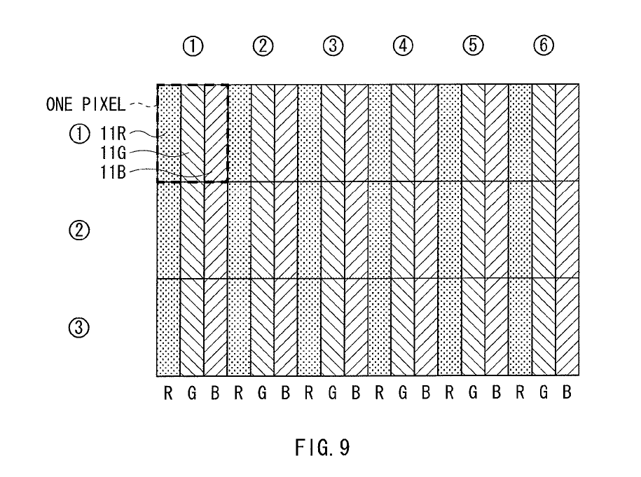

The display section 1 is made up of a two-dimensional display panel of a transmission type including for example a liquid crystal display panel of a transmission type, and has, as illustrated in FIG. 9 for example, a plurality of pixels each composed of a pixel for R (red) 11R, a pixel for G (green) 11G, and a pixel for B (blue) 11B, and the pixels are disposed in a matrix. The display section 1 modulates light from the light source device according to image data on a pixel by pixel basis to display a two-dimensional image. On the display section 1, a plurality of perspective images based on three-dimensional image data and an image based on two-dimensional image data are arbitrarily and selectively displayed in a switchable manner. It is to be noted that, the three-dimensional image data is, for example, data which contains a plurality of perspective images corresponding to a plurality of viewing angle directions in a three-dimensional display. For example, in the case of a two-view three-dimensional display, the three-dimensional image data is data of perspective images to be displayed for right eye and left eye. When a display is performed in the three-dimensional display mode, for example, a synthetic image containing, in one screen, a plurality of perspective images of a striped shape is generated and displayed. It is to be noted that, the specific example of the correspondence relationship between an allocation pattern of a plurality of perspective images to respective pixels of the display section 1 and a layout pattern of scattering regions 31 is described later in detail.

The first light source 2 is configured of, for example, a fluorescent lamp such as a CCFL (Cold Cathode Fluorescent Lamp), and an LED (Light Emitting Diode). The first light source 2 irradiates first illumination light L1 (FIG. 1) toward the inside of the light guide plate 3 from a side direction. At least one first light source 2 is disposed on the side of the light guide plate 3. For example, if the planar shape of the light guide plate 3 is a square shape with four sides, then at least one first light source 2 need only be disposed on any one of the four sides. FIG. 1 illustrates an exemplary configuration in which the first light sources 2 are disposed on two sides of the light guide plate 3 opposite to each other. The first light sources 2 are on (light-on)/off (light-off) controlled in response to switching modes between the two-dimensional display mode and the three-dimensional display mode. Specifically, the first light sources 2 are set to the light-on state in the case where an image based on three-dimensional image data is displayed on the display section 1 (in the case of the three-dimensional display mode), and set to the light-off state or the light-on state in the case where an image based on two-dimensional image data is displayed on the display section 1 (in the case of the two-dimensional display mode).

The second light source 7 is disposed to face the light guide plate 3 on the side on which the second internal reflection face 3B is formed. The second light source 7 irradiates second illumination light L10 toward the second internal reflection face 3B from the external side (see FIG. 2 and FIG. 3). The second light source 7 may be any light source as long as it is planar light source which emits light having uniform in-plane luminance, and the structure itself is not specifically limited, and commercially-available planar backlight may be used. For example, a structure in which a light emitting body such as a CCFL and an LED and a light diffusion plate for making in-plane luminance uniform are used may be conceivable. The second light source 7 is on (light-on)/off (light-off) controlled in response to switching modes between the two-dimensional display mode and the three-dimensional display mode. Specifically, the second light source 7 is set to the light-off state in the case where an image based on three-dimensional image data is displayed on the display section 1 (in the case of the three-dimensional display mode), and set to the light-on state in the case where an image based on two-dimensional image data is displayed on the display section 1 (in the case of the two-dimensional display mode).

The light guide plate 3 is configured of, for example, a transparent plastic plate made of acrylic resin or the like. The entirety of the light guide plate 3 is transparent except for the second internal reflection face 3B. For example, if the planar shape of the light guide plate 3 is a square shape, then the entirety of the first internal reflection face 3A and the four sides thereof are transparent.

The entirety of the first internal reflection face 3A is minor finished, so that light rays inputted at an incident angle which satisfies a total reflection condition undergoes internal total reflection in the light guide plate 3, and light rays which do not satisfy the total reflection condition is emitted to the outside.

The second internal reflection face 3B has scattering regions 31 and a total reflection area 32. As described later, the scattering region 31 is formed by laser processing, sandblast processing, paint processing on the surface of the light guide plate 3, or by bonding a sheet-like light scattering member onto the surface of the light guide plate 3. In the three-dimensional display mode, the scattering regions 31 and the total reflection area 32 of the second internal reflection face 3B function as an opening part (slit part) and a blocking part of a parallax barrier, respectively, for the first illumination light L1 from the first light source 2. On the second internal reflection face 3B, the scattering regions 31 and the total reflection area 32 are provided in a pattern as a structure corresponding to a parallax barrier. In other words, the total reflection area 32 is provided in a pattern corresponding to a blocking part of a parallax barrier, and the scattering region 31 is provided in a pattern corresponding to an opening part of the parallax barrier. It is to be noted that, as a barrier pattern of the parallax barrier, various types of barrier patterns including, for example, a stripe-shaped pattern in which a number of opening parts each having a vertically long slit shape are arranged side by side through the blocking part in a horizontal direction, and the like may be used, and the barrier pattern is not specifically limited.

The total reflection area 32 on the first internal reflection face 3A and the second internal reflection face 3B causes light rays inputted at an incident angle θ1 satisfying the total reflection condition undergo internal total reflection (causes light rays inputted at the incident angle θ1 greater than a predetermined critical angle α undergo internal total reflection). Thus, first illumination light L1 inputted from the first light source 2 at the incident angle θ1 satisfying the total reflection condition is caused to undergo internal total reflection between the first internal reflection face 3A and the total reflection area 32 of the second internal reflection face 3B, and guided to the side direction. As illustrated in FIG. 2 or FIG. 3, the total reflection area 32 allows second illumination light L10 from the second light source 7 to pass therethrough, and emits the second illumination light L10 toward the first internal reflection face 3A as light rays which do not satisfy the total reflection condition.

It is to be noted that, when the refractive index of the light guide plate 3 is represented by n1, and the refractive index of the medium (air layer) outside of the light guide plate 3 is represented by n0 (<n1), the critical angle α is expressed as follows. Here, α and θ1 are angles with respect to the normal of the surface of the light guide plate. The incident angle θ1 which satisfies the total reflection condition is θ1>α.

sin α=n0/n1

As illustrated in FIG. 1, the scattering region 31 allows first illumination light L1 from the first light source 2 to be reflected in a scattered manner, and emits at least a part of the first illumination light L1 toward the first internal reflection face 3A as light rays (scattering light beam L20) which do not satisfy the total reflection condition.

### [Modification of Configuration of Display]

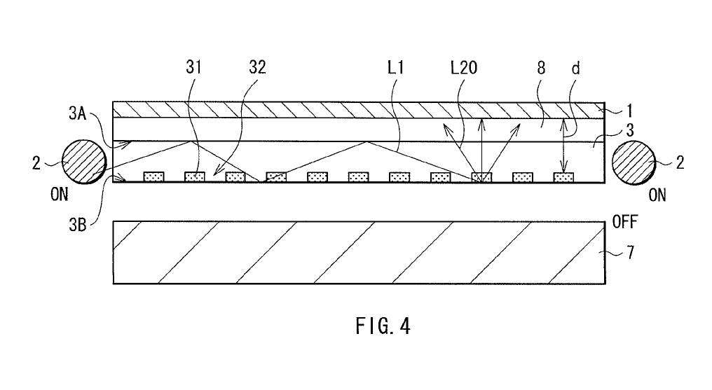

To perform the spatial separation of a plurality of perspective images displayed on the display section 1 in the display illustrated in FIG. 1, a pixel section of the display section 1 and the scattering regions 31 of the light guide plate 3 need to be oppositely disposed with a predetermined distance d maintained therebetween. While in FIG. 1 the space between the display section 1 and the light guide plate 3 is an air space, a spacer 8 may be disposed between the display section 1 and the light guide plate 3 to maintain the predetermined distance d, as a first modification illustrated in FIG. 4. The spacer 8 may be any material as long as it is colorless and transparent and causes little scattering, and for example, a PMMA may be used. The spacer 8 may be provided so as to cover all of the surface of the back side of the display section 1 and the surface of the light guide plate 3, or may be partially provided only as needed to maintain the distance d.

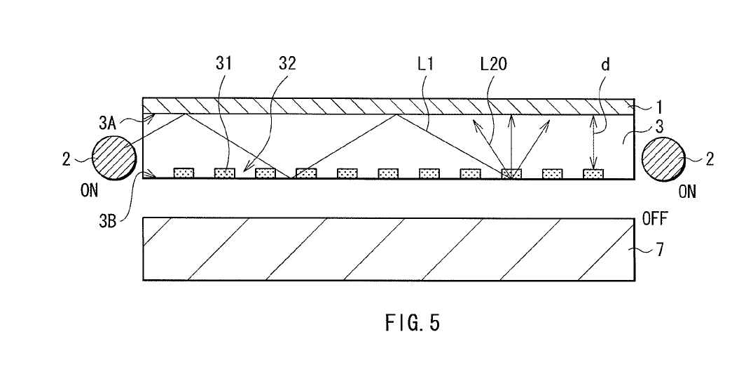

In addition, like a second modification illustrated in FIG. 5, the air space may be removed by generally increasing the thickness of the light guide plate 3.

### [Specific Configuration Example of Scattering Region 31]

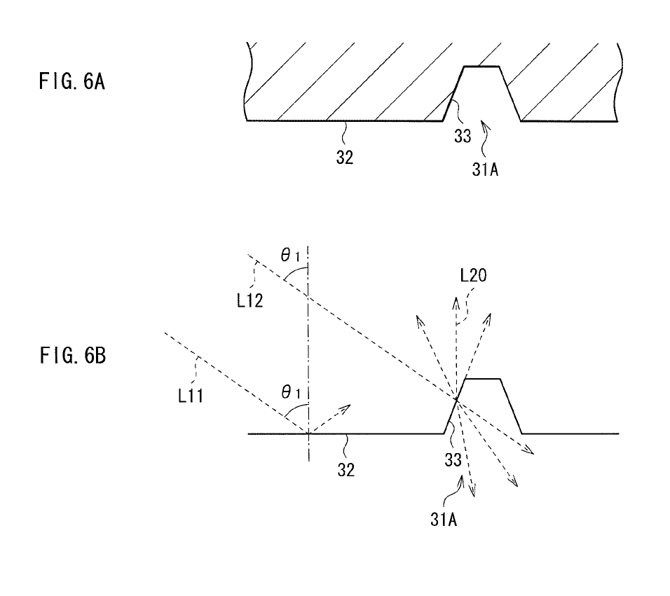

FIG. 6A illustrates a first exemplary configuration of the second internal reflection face 3B of the light guide plate 3. FIG. 6B schematically illustrates a reflection mode and a scattering mode of light rays on the second internal reflection face 3B in the first exemplary configuration illustrated in FIG. 6A. The first exemplary configuration is an exemplary configuration in which the scattering region 31 is a scattering region 31A recessed with respect to the total reflection area 32. Such a recessed scattering region 31A may be formed by, for example, sandblast processing or laser processing. For example, the recessed scattering region 31A may be formed by performing laser processing on a portion corresponding to the scattering region 31A after the surface of the light guide plate 3 is minor finished. In the case of the first exemplary configuration, first illumination light L11 from the first light source 2 incident on the second internal reflection face 3B at the incident angle θ1 satisfying the total reflection condition undergoes internal total reflection in the total reflection area 32. On the other hand, even if first illumination light L12 is incident on the recessed scattering region 31A at the same incident angle θ1 as the total reflection area 32, a part of the inputted first illumination light L12 does not satisfy the total reflection condition at a recessed side face portion 33, so that a part of the first illumination light L12 is transmitted in a scattered manner, and the other part of the first illumination light L12 is reflected in a scattered manner. The part of or all of the light beam (scattering light beam L20) reflected in a scattered manner is emitted toward the first internal reflection face 3A as light rays which do not satisfy the total reflection condition as illustrated in FIG. 1.

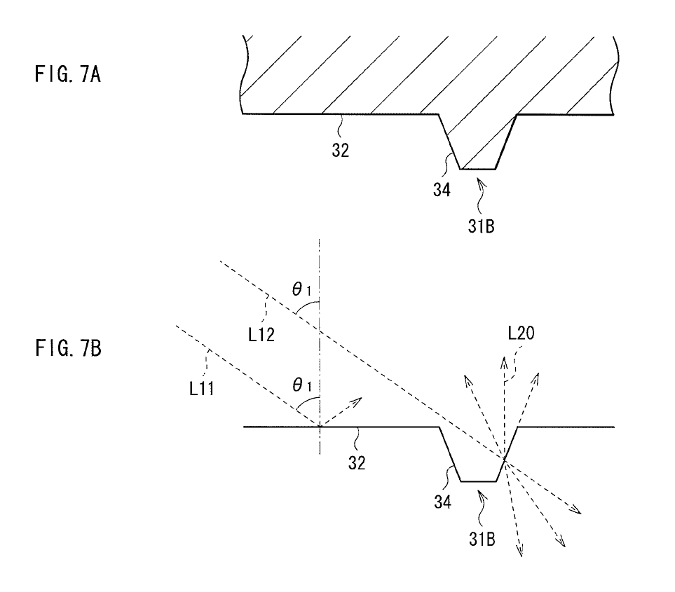

FIG. 7A illustrates a second exemplary configuration of the second internal reflection face 3B of the light guide plate 3. FIG. 7B schematically illustrates a reflection mode and a scattering mode of light rays on the second internal reflection face 3B in the second exemplary configuration illustrated in FIG. 7A. The second exemplary configuration is an exemplary configuration in which the scattering region 31 is a scattering region 31B raised with respect to the total reflection area 32. Such a raised scattering region 31B may be formed by performing mold processing on the surface of the light guide plate 3 with use of a metal mold, for example. In this case, a portion corresponding to the total reflection area 32 is mirror finished by the surface of the metal mold. In the case of the second exemplary configuration, first illumination light L11 from the first light source 2 incident on the second internal reflection face 3B at the incident angle θ1 satisfying the total reflection condition undergoes internal total reflection in the total reflection area 32. On the other hand, even if first illumination light L12 is incident on the raised scattering region 31B at the same incident angle θ1 as the total reflection area 32, a part of the inputted first illumination light L12 does not satisfy the total reflection condition at a raised side face portion 34, so that a part of the first illumination light L12 is transmitted in a scattered manner, and the other part of the first illumination light L12 is reflected in a scattered manner. The part or all of the light beam (scattering light beam L20) reflected in a scattered manner is emitted toward the first internal reflection face 3A as light rays which do not satisfy the total reflection condition as illustrated in FIG. 1.

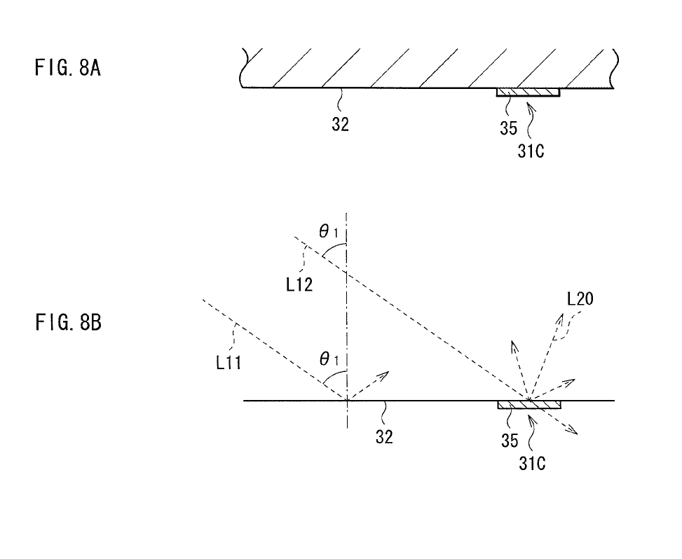

FIG. 8A illustrates a third exemplary configuration of the second internal reflection face 3B of the light guide plate 3. FIG. 8B schematically illustrates a reflection mode and a scattering mode of light rays on the second internal reflection face 3B in the third exemplary configuration illustrated in FIG. 8A. In the exemplary configurations in FIG. 6A and FIG. 7A, the surface of the light guide plate 3 is subjected to surface treatment to form the scattering region 31 having a shape different from that of the total reflection area 32. In contrast, a scattering region 31C of an exemplary configuration in FIG. 8A is formed, not by surface treatment, but by disposing a light scattering member 35 made of a material different from that of the light guide plate 3 on the surface of the light guide plate 3 corresponding to the second internal reflection face 3B. In this case, the scattering region 31C may be formed by, for example, patterning white paint (for example, barium sulfate) as the light scattering member 35 on the surface of the light guide plate 3 by screen printing. In the case of the third exemplary configuration, first illumination light L11 from the first light source 2 incident on the second internal reflection face 3B at the incident angle θ1 satisfying the total reflection condition undergoes internal total reflection in the total reflection area 32. On the other hand, even if first illumination light L12 is incident on the scattering region 31C, in which the light scattering member 35 is disposed, at the same incident angle θ1 as the total reflection area 32, a part of the inputted first illumination light L12 is transmitted in a scattered manner, and the other part of the first illumination light L12 is reflected in a scattered manner by the light scattering member 35. The part or all of the light rays reflected in a scattered manner is emitted toward the first internal reflection face 3A as light rays which do not satisfy the total reflection condition.

### [Basic Operation of Display]

In the display, when a display is performed in the three-dimensional display mode, an image is displayed on the display section 1 based on three-dimensional image data, and an on (light-on)/off (light-off) control of the first light sources 2 and the second light source 7 is performed for a three-dimensional display. Specifically, as illustrated in FIG. 1, the first light sources 2 are set to an on (light-on) state, and the second light source 7 is set to an off (light-off) state. In this state, first illumination light L1 from the first light source 2 is caused to repeatedly undergo internal total reflection between the first internal reflection face 3A and the total reflection area 32 of the second internal reflection face 3B in the light guide plate 3. Then, the first illumination light L1 is guided from one side on which the first light source 2 is disposed to the other side opposite thereto, and emitted from the other side. On the other hand, a part of the first illumination light L1 from the first light source 2 is reflected in a scattered manner in the scattering region 31 of the light guide plate 3. Then, the part of the first illumination light L1 from the first light source 2 is allowed to pass through the first internal reflection face 3A of the light guide plate 3, and be emitted to the outside of the light guide plate 3. Thus, it is possible to allow the light guide plate itself to function as a parallax barrier. In other words, it is possible to allow the light guide plate itself to, equivalently, function as a parallax barrier in which the scattering region 31 serves as an opening part (slit part) and the total reflection area 32 serves as a blocking part for the first illumination light L1 from the first light source 2. With this configuration, a three-dimensional display is performed, equivalently, by a parallax barrier system in which a parallax barrier is disposed on the back side of the display section 1.

On the other hand, when a display is performed in the two-dimensional display mode, an image is displayed on the display section 1 based on two-dimensional image data, and an on (light-on)/off (light-off) control of the first light sources 2 and the second light source 7 is performed for a two-dimensional display. Specifically, as illustrated in FIG. 2, the first light sources 2 are set to an off (light-off) state, and the second light source 7 is set to an on (light-on) state. In this case, the second illumination light L10 from the second light source 7 is allowed to pass through the total reflection area 32 of the second internal reflection face 3B, and is emitted to the outside of the light guide plate 3 as light rays which do not satisfy the total reflection condition, from substantially the entirety of the first internal reflection face 3A. In other words, the light guide plate 3 functions as a planar light source similar to typical backlights. Thus, a two-dimensional display is equivalently performed by a backlight system in which a typical backlight is disposed on the back side of the display section 1.

It is to be noted that, while the second illumination light L10 is emitted from substantially the entirety of the light guide plate 3 even when only the second light source 7 is turned on, it is possible to turn on the first light sources 2 together with the second light source 7 as illustrated in FIG. 3, as necessary. With this configuration, for example, in the case where difference in a luminance distribution is caused at portions corresponding to the scattering regions 31 and the total reflection area 32 when only the second light source 7 is turned on, it is possible to optimize the luminance distribution over the entire face by appropriately adjusting the light-on state of the first light sources 2 (by performing an on-off control, or by adjusting the amount of lighting). It should be noted that, in the case where a two-dimensional display is performed, for example, if a correction of luminance may be sufficiently performed on the display section 1 side, lighting with use of only the second light source 7 is acceptable.

### [Correspondence Relationship Between Allocation Pattern of Perspective Images and Layout Pattern of Scattering Region 31]

In the display, when a display is performed in the three-dimensional display mode, a plurality of perspective images are allocated to respective pixels in a predetermined allocation pattern and displayed on the display section 1. A plurality of the scattering regions 31 of the light guide plate 3 are provided in a predetermined layout pattern corresponding to the predetermined allocation pattern.

Below, a specific example of the correspondence relationship between the allocation pattern of perspective images and the layout pattern of the scattering regions 31 is described. As illustrated in FIG. 9, the pixel structure of the display section 1 has a plurality of pixels each having a pixel for red 11R, a pixel for green 11G, and a pixel for blue 11B, and the plurality of pixels are disposed in a first direction (vertical direction) and a second direction (horizontal direction) in a matrix. Pixels 11R, 11G, and 11B of the three colors are periodically and alternately laid out in a horizontal direction, and respective pixels 11R, 11G, and 11B of the same color are laid out in a vertical direction. In the case of this pixel structure, in a state for displaying a typical two-dimensional image on the display section 1 (two-dimensional display mode), a combination of the pixels 11R, 11G, and 11B of the three colors successively positioned in a horizontal direction serves as one pixel (one unit pixel of a 2D color display) for performing a two-dimensional color display. In FIG. 9, there are illustrated six unit pixels for a 2D color display in a horizontal direction and three unit pixels therefor in a vertical direction.

(A) of FIG. 10 illustrates an exemplary correspondence relationship between the layout pattern of the scattering regions 31 and the allocation pattern of perspective images in the case where two perspective images (first and second perspective images) are allocated to respective pixels of the display section 1 in the pixel structure in FIG. 9. (B) of FIG. 10 is a cross sectional view taken along A-A′ portion in (A) of FIG. 10. (B) of FIG. 10 schematically illustrates a separating state of two perspective images. In this example, one unit pixel of the 2D color display is allocated as one pixel for displaying one perspective image. In addition, pixels are allocated so that the first perspective image and the second perspective image are alternately displayed in a horizontal direction. Therefore, two unit pixels of a 2D color display combined in a horizontal direction serves as one unit image (one stereoscopic pixel) in a three-dimensional display. As illustrated in FIG. (B) of 10, in the state where a first perspective image reaches only a right eye 10R of a viewer and a second perspective image reaches only a left eye 10L of the viewer, stereoscopic viewing is performed. In this example, the position of the scattering region 31 in a horizontal direction is such that the scattering region 31 is disposed so as to be positioned at the substantially center portion of one unit image in a three-dimensional display.

Here, a width D1 in a horizontal direction of the scattering region 31 is a size which has a predetermined relationship with a width D2 of one pixel for displaying one perspective image. Specifically, the width D1 of the scattering region 31 is preferably 0.5 times or more and 1.5 times or less than the width D2. As the width D1 of the scattering region 31 becomes greater, the amount of light scattered at the scattering region 31 increases, and the amount of light emitted from the light guide plate 3 increases. Thus, luminance may be increased. It should be noted that, if the width D1 of the scattering region 31 exceeds 1.5 times of the width D2, so-called cross talk is caused in which light from a plurality of perspective images is observed in a mixed state, which is not preferable. Conversely, as the width D1 of the scattering region 31 becomes smaller, the amount of light scattered at the scattering region 31 decreases, and the amount of light emitted from the light guide plate 3 decreases. Thus, luminance is decreased. If the width D1 of the scattering region 31 is smaller than 0.5 times of the width D2, luminance becomes too low and an image becomes too dark as an image display, which is not preferable.

### [Relationship Between Height (Depth) of Scattering Region 31 and Luminance]

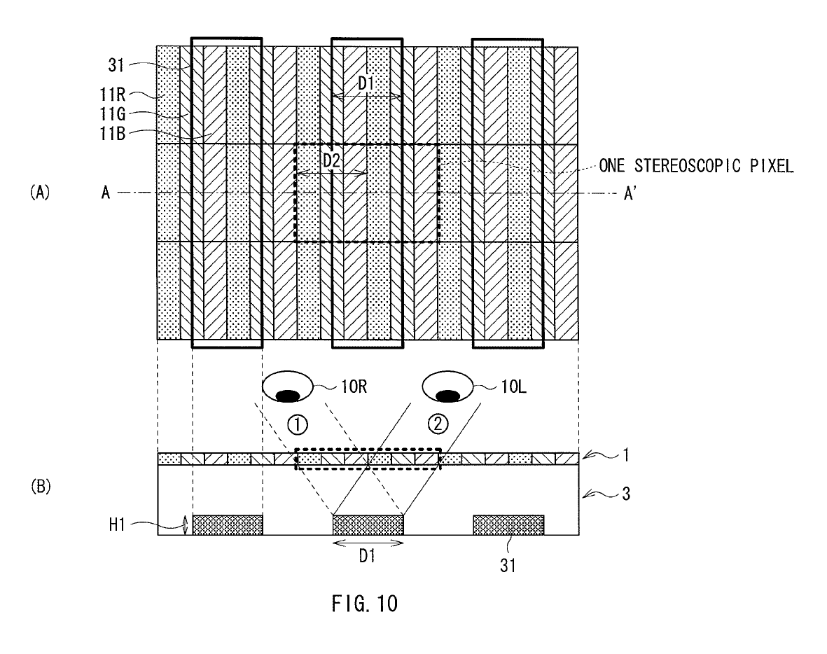

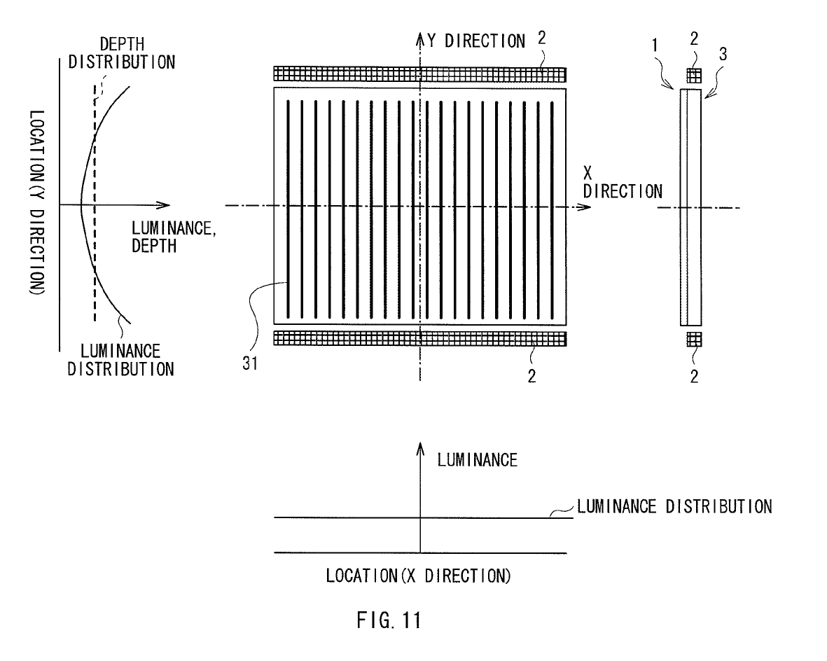

FIG. 11 and FIG. 12 illustrate luminance distributions in a Y direction (first direction, or vertical direction in a plane), and an X direction (second direction, or horizontal direction in a plane) in the case where only the first light sources 2 are set to an on (light-on) state in the light source device illustrated in FIG. 1.

FIG. 11 illustrates, together with the luminance distribution, a plan view of the light source device and a side view of the light source device seen in an X direction. FIG. 11 also illustrates a height (depth) distribution in a Y direction of the scattering region 31. FIG. 11 illustrates the luminance distribution in the case where the first light sources 2 are disposed on a first side and a second side opposite to each other in the Y direction. Further, a plurality of the scattering regions 31 extend in the Y direction between the first side and the second side, and are arranged side by side in the X direction. A height (depth) H1 with respect to the surface of the light guide plate (or, a second internal reflection face 3B in the present embodiment) of the scattering region 31 is the same over the entire face. In the configuration where the first light sources 2 are disposed in the Y direction and the depth distribution of the scattering region 31 is uniform over the entire face as described above, the luminance distribution of light emitted from the light guide plate 3 in the Y direction has a tendency that the closer to predetermined sides (first side and second side) on which the first light sources 2 are disposed, the relatively higher the luminance is, whereas the farther from the predetermined sides, the relatively lower the luminance is. Since in the example of FIG. 11, the first light sources 2 are disposed on two predetermined sides in the Y direction, luminance is relatively higher at the position close to the two predetermined sides in the Y direction, and luminance is relatively lower at the middle point between the two predetermined sides in the Y direction. On the other hand, the luminance distribution in the X direction is constant irrespective of the position.

FIG. 12 illustrates, together with the luminance distribution, a plan view of the light source device and a side view of the light source device seen in a Y direction. FIG. 12 also illustrates a height (depth) distribution in a Y direction of the scattering region 31. FIG. 12 illustrates the luminance distribution in the case where the first light sources 2 are disposed on a third side and a fourth side opposite to each other in the X direction. The height (depth) H1 with respect to the surface of the light guide plate of the scattering region 31 is the same over the entire face. In the configuration where the first light sources 2 are disposed in the X direction and the depth distribution of the scattering region 31 is uniform over the entire face as described above, the luminance distribution of light emitted from the light guide plate 3 in the X direction has a tendency that the closer to predetermined sides (third side and fourth side) on which the first light sources 2 are disposed, the relatively higher the luminance is, whereas the farther from the predetermined sides, the relatively lower the luminance is. Since in the example of FIG. 12, the first light sources 2 are disposed on two predetermined sides in the X direction, luminance is relatively higher at the position close to the two predetermined sides in the X direction, and luminance is relatively lower at the middle point between the two predetermined sides in the X direction. On the other hand, the luminance distribution in the Y direction is constant irrespective of the position.

As illustrated in FIG. 11 and FIG. 12, according to the position at which the first light sources 2 are disposed and the height (depth) H1 of the scattering region 31, the luminance distribution is partially varied, causing ununiformity in luminance. Ideally, the luminance distribution is even irrespective of the position in both of the X direction and the Y direction.

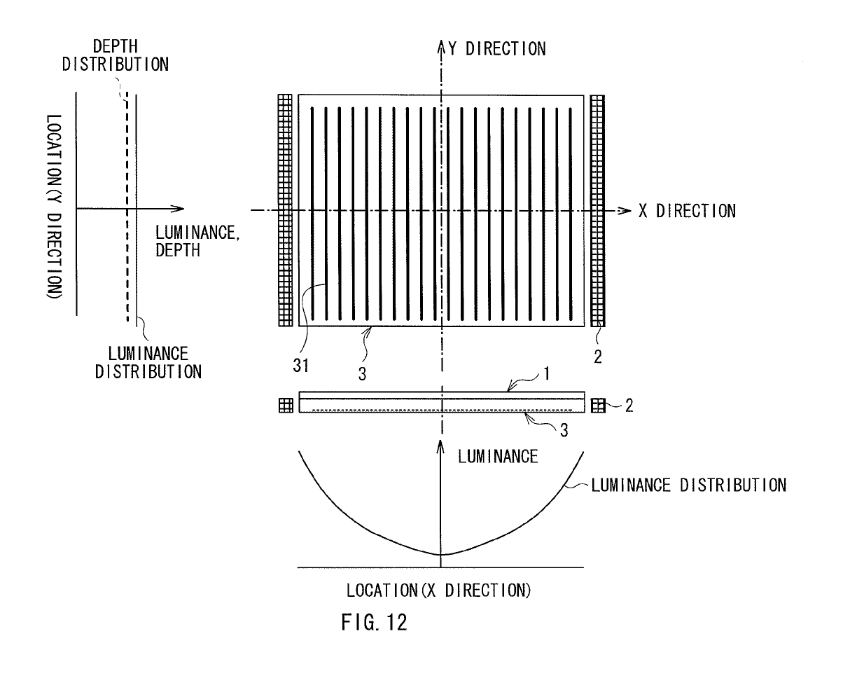

Next, referring to FIG. 13 to FIG. 15, a method of improving the above-mentioned luminance distribution is described. It is to be noted that, while in FIG. 13 to FIG. 15 an exemplary case where the first light sources 2 are disposed in the Y direction is described, the luminance distribution may be improved in a similar way also in the case where the first light sources 2 are disposed in the X direction.

In order to improve the luminance distribution, it is necessary to adopt a structure in which the height (depth) H1 of the scattering region 31 is varied according to the distance from a predetermined side on which the first light source 2 is disposed so that the height H1 is decreased toward the predetermined side of the light guide plate 3. It is to be noted that, the height (depth) H1 of the scattering region 31 is the height from the surface of the light guide plate to an internal direction in the case of the recessed scattering region 31A illustrated in FIG. 6A. Meanwhile, the height (depth) H1 of the scattering region 31 is the height from the surface of the light guide plate to an external direction in the case of the raised scattering region 31B illustrated in FIG. 7A, or the scattering region 31C such as a printed pattern illustrated in FIG. 8A.

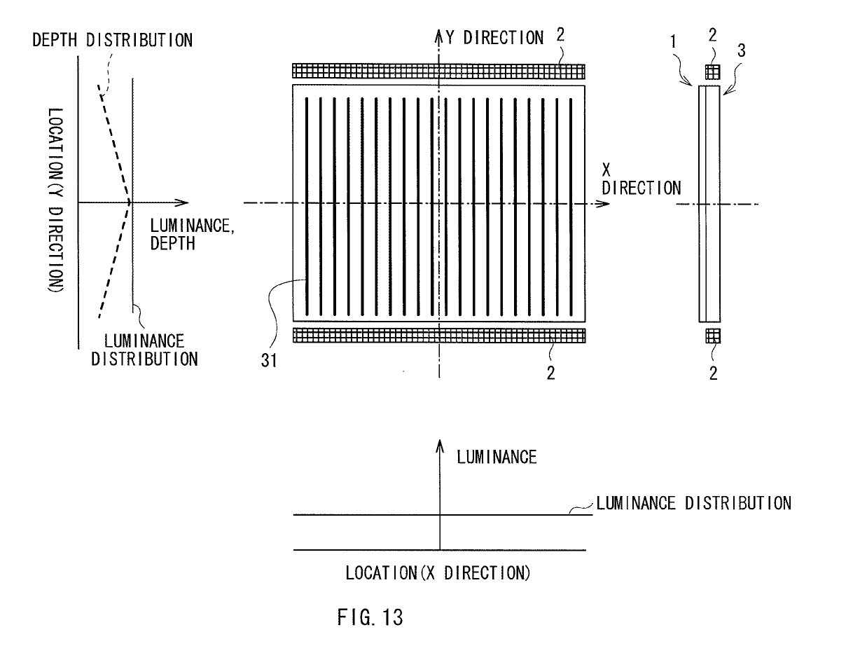

FIG. 13 illustrates an example in which the luminance distribution is improved in such a manner that, in the structure of the scattering region 31, the height (depth) H1 is decreased toward two predetermined sides of the light guide plate 3 in the Y direction, and the height (depth) H1 is increased toward the middle point between the two predetermined sides. In the first the example in FIG. 13, the height (depth) H1 of the scattering region 31 is continuously varied at a constant change rate. It should be noted that, the change rate of the height (depth) H1 may not necessarily be constant, and as illustrated in the second example in FIG. 14, for example, the change rate of the height (depth) H1 may be varied so that the depth distribution forms a curved line.

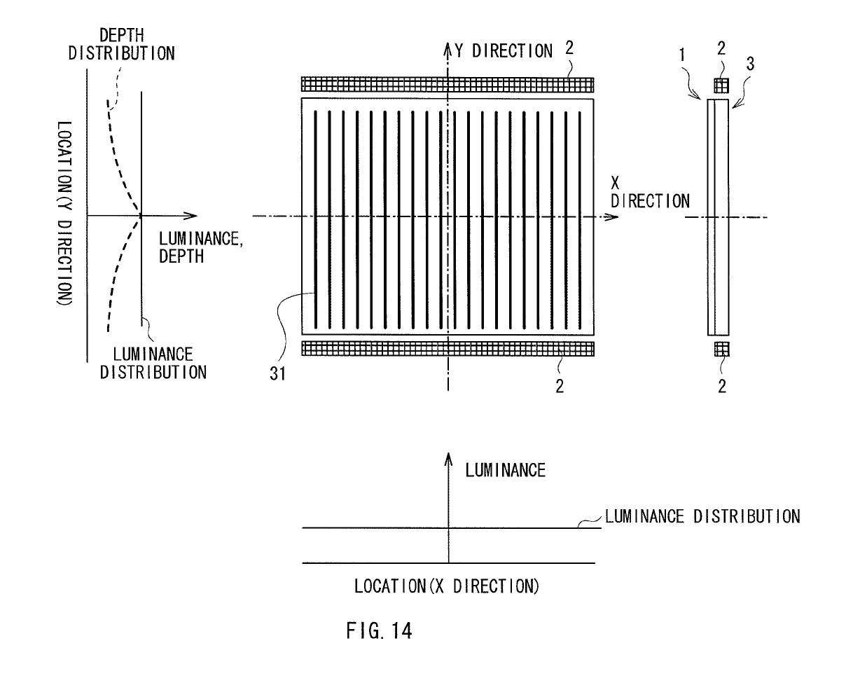

While, in the examples in FIG. 13 and FIG. 14, a structure is adopted in which the height (depth) H1 of the scattering region 31 is continuously varied according to the distance from the two predetermined sides, it is also possible to adopt a structure in which, as illustrated in FIG. 15, the height (depth) H1 is varied in a step-by-step manner (in a stepwise manner) according to the distance from the two predetermined sides.

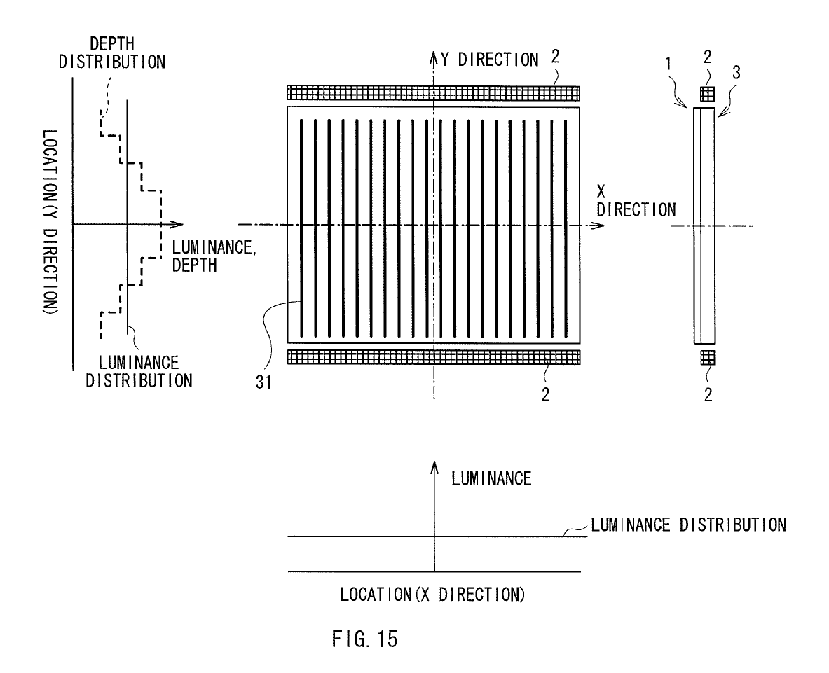

FIG. 16 illustrates a result of an actual measurement of the difference in the luminance distribution caused by the difference of the structure (depth distribution) of the scattering region 31. In FIG. 16, the depth distribution and the luminance distribution corresponding to the example illustrated in FIG. 11 and the example illustrated in FIG. 15 are illustrated. As illustrated in FIG. 16, in the case where the depth distribution is uniform as the structure of the scattering region 31, ununiformity of the luminance distribution is significant. On the other hand, in the case where the depth distribution is optimized in a stepwise manner as the structure of the scattering region 31, the luminance distribution is improved so as to exhibit less ununiformity.

### [Relationship Between Length of Scattering Region 31 and Luminance]

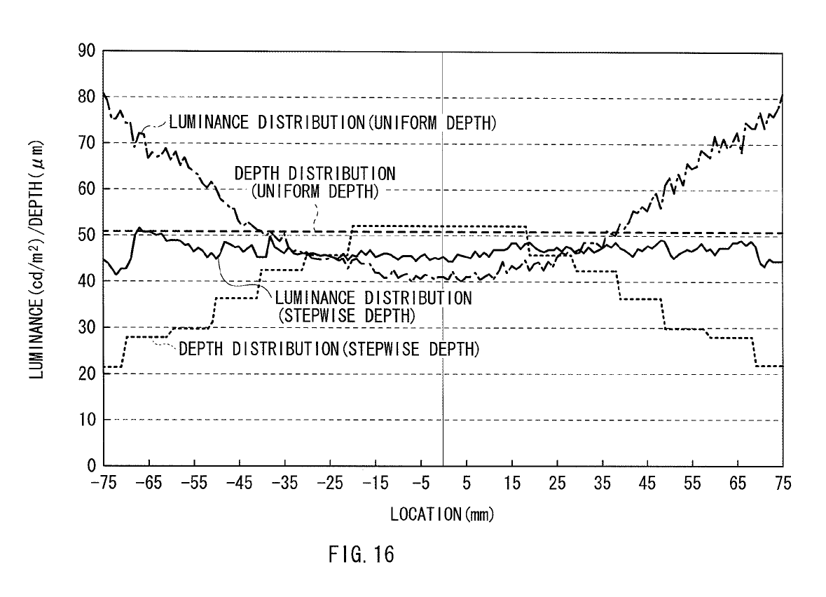

While, in FIG. 11 to FIG. 16, the luminance distribution is described focusing on the height (depth) of the scattering region 31, the luminance distribution is next described focusing on the length of the scattering region 31 referring to FIG. 17 to FIG. 20.

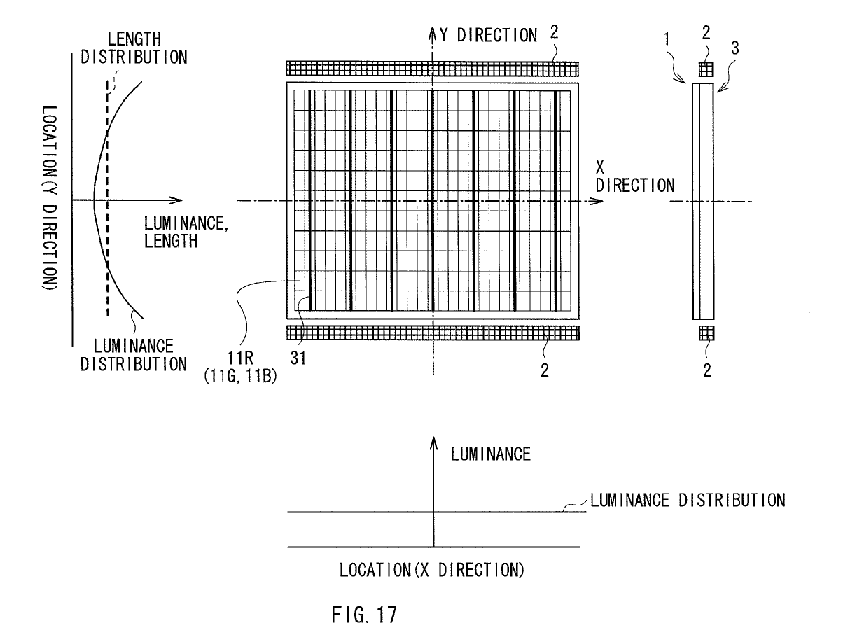

FIG. 17 and FIG. 18 illustrate luminance distributions in a Y direction (first direction, or vertical direction in a plane), and X direction (second direction, or horizontal direction in a plane) in the case where only the first light sources 2 are set to an on (light-on) state in the light source device illustrated in FIG. 1. It is to be noted that, FIG. 17 and FIG. 18 illustrate an exemplary case in which the number of perspectives is four.

FIG. 17 illustrates, together with the luminance distribution, a plan view of the light source device and a side view of the light source device seen in an X direction. FIG. 17 illustrates the luminance distribution in the case where the first light sources 2 are disposed on a first side and a second side opposite to each other in the Y direction. FIG. 17 also illustrates the length distribution in the Y direction of the scattering region 31. A plurality of the scattering regions 31 extends in the Y direction between the first side and the second side, and is arranged side by side in the X direction. The length distribution of the scattering region 31 illustrated in FIG. 17 corresponds to the length of the scattering region 31 with respect to the pixels 11R, 11G, and 11B. In the example in FIG. 17, the length of the scattering region 31 with respect to the pixels 11R, 11G, and 11B is uniform. It is to be noted that, the height (depth) H1 with respect to the surface of the light guide plate (or, a second internal reflection face 3B in the present embodiment) of the scattering region 31 is the same over the entire face. In the configuration where the first light sources 2 are disposed in the Y direction and the depth distribution and the length distribution of the scattering region 31 is uniform over the entire face as described above, the luminance distribution of light emitted from the light guide plate 3 in the Y direction has a tendency that the closer to predetermined sides (first side and second side) on which the first light sources 2 are disposed, the relatively higher the luminance is, whereas the farther from the predetermined sides, the relatively lower the luminance is. Since in the example of FIG. 17, the first light sources 2 are disposed on two predetermined sides in the Y direction, luminance is relatively higher at the position close to the two predetermined sides in the Y direction, and luminance is relatively lower at the middle point between the two predetermined sides in the Y direction. On the other hand, the luminance distribution in the X direction is constant irrespective of the position.

FIG. 18 illustrates, together with the luminance distribution, a plan view of the light source device and a side view of the light source device seen in an Y direction. FIG. 18 illustrates the luminance distribution in the case where the first light sources 2 are disposed on a third side and a fourth side opposite to each other in the X direction. FIG. 18 also illustrates the length distribution in the Y direction of the scattering region 31. The structure of the scattering region 31 is similar to the example of FIG. 17, and the length of the scattering region 31 with respect to the pixels 11R, 11G, and 11B is uniform. In addition, the height (depth) H1 with respect to the surface of the light guide plate of the scattering region 31 is the same over the entire face. In the case where the first light sources 2 are disposed in the X direction and the depth distribution and the length distribution of the scattering region 31 is uniform over the entire face as described above, the luminance distribution of light emitted from the light guide plate 3 in the X direction has a tendency that the closer to predetermined sides (third side and fourth side) on which the first light sources 2 are disposed, the relatively higher the luminance is, whereas the farther from the predetermined sides, the relatively lower the luminance is. Since in the example of FIG. 18, the first light sources 2 are disposed on the two predetermined sides in the X direction, luminance is relatively higher at the position close to the two predetermined sides in the X direction, and luminance is relatively lower at the middle point between the two predetermined sides in the X direction. On the other hand, the luminance distribution in the Y direction is constant irrespective of the position.

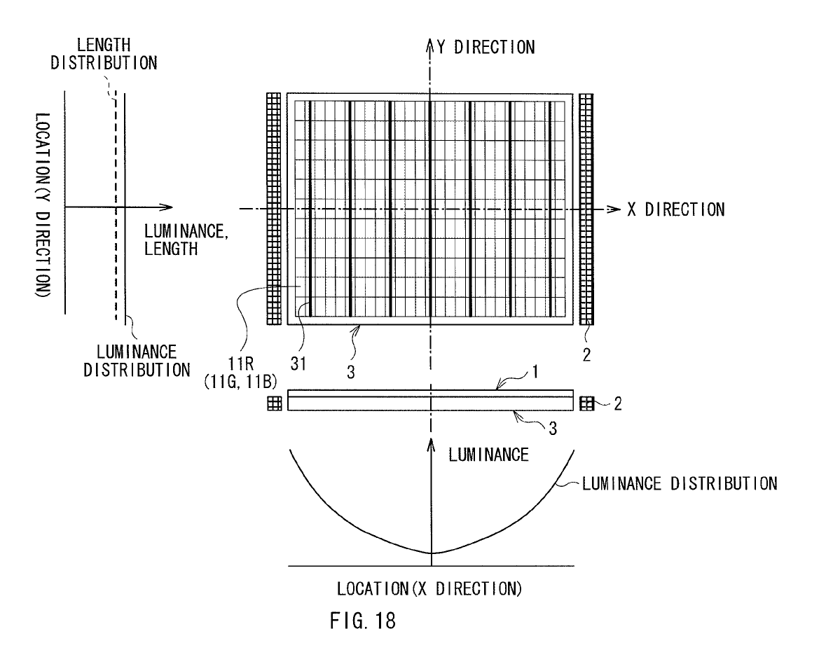

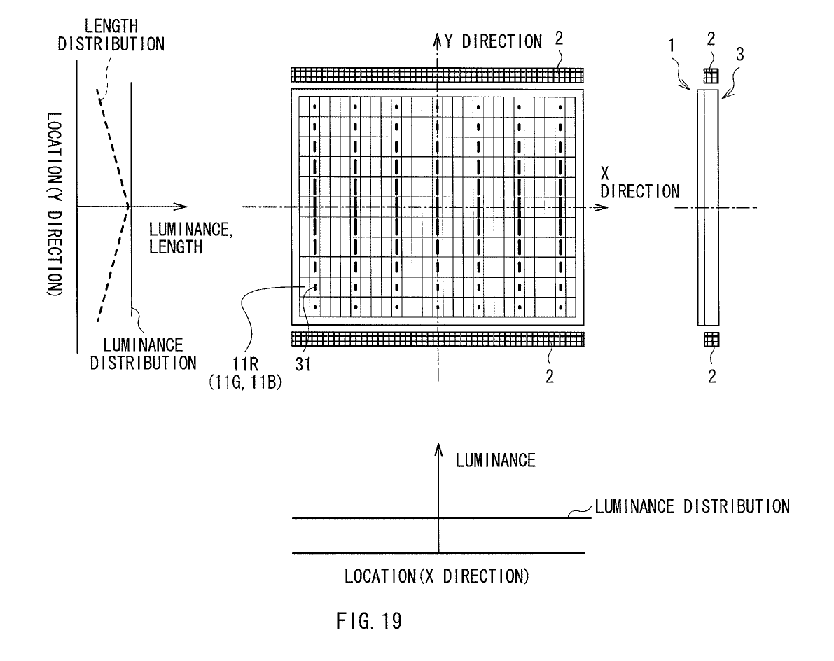

Next, referring to FIG. 19 and FIG. 20, a method for improving the luminance distribution with respect to the structure in FIG. 17 and FIG. 18 is described. In the above-mentioned example in FIG. 13 to FIG. 15, the height (depth) H1 of the scattering region 31 is varied according to the distance from the predetermined side on which the first light source 2 is disposed. On the other hand, in FIG. 19 and FIG. 20, the length of the scattering region 31 with respect to pixels 11R, 11G, and 11B is varied to improve the luminance distribution. In FIG. 19 and FIG. 20, in order to vary the length of the scattering region 31 with respect to pixels 11R, 11G, and 11B, the scattering region 31 is not continuously provided in the Y direction, but is provided in a divided manner in the Y direction.

FIG. 19 illustrates an example in which the luminance distribution is improved with respect to the structure in FIG. 17. In the example in FIG. 19, the length of the scattering region 31 with respect to pixels 11R, 11G, and 11B is decreased (shortened) toward two predetermined sides in the Y direction of the light guide plate 3, and is increased (lengthened) toward the middle point between the two predetermined sides. In the example in FIG. 19, the length of the scattering region 31 is varied at a constant change rate. It should be noted that, the change rate of the length may not necessarily be constant, and similarly to the example of the depth distribution in FIG. 14, for example, the change rate of the length may be varied so that the length distribution forms a curved line.

FIG. 20 illustrates an example in which the luminance distribution is improved with respect to the structure in FIG. 18. In the example in FIG. 20, the length of the scattering region 31 with respect to pixels 11R, 11G, and 11B is decreased (shortened) toward two predetermined sides in the X direction of the light guide plate 3, and increased (lengthened) toward the middle point between the two predetermined sides. In the example in FIG. 20, the length of the scattering region 31 is varied at a constant change rate. It should be noted that, the change rate of the length may not necessarily be constant, and similarly to the example of the depth distribution in FIG. 14, for example, the change rate of the length may be varied so that the length distribution forms a curved line.

It is to be noted that, while, in the above described examples, only one of the height and the length of the scattering region 31 is varied to improve the luminance distribution, it is also possible that both of the height and the length of the scattering region 31 are optimized to vary the general shape of the scattering region 31.

### [Modification of Layout Pattern of Scattering Region 31]

While, in the exemplary case in FIG. 13 to FIG. 15, as a layout pattern of the scattering regions 31, the scattering regions 31 continuously (successively) extend in the Y direction and are arranged side by side in the X direction, the luminance distribution may be improved in a similar way as in FIG. 13 to FIG. 15 even in the case where the scattering regions 31 are laid out in a layout pattern different from that in FIG. 13 to FIG. 15.

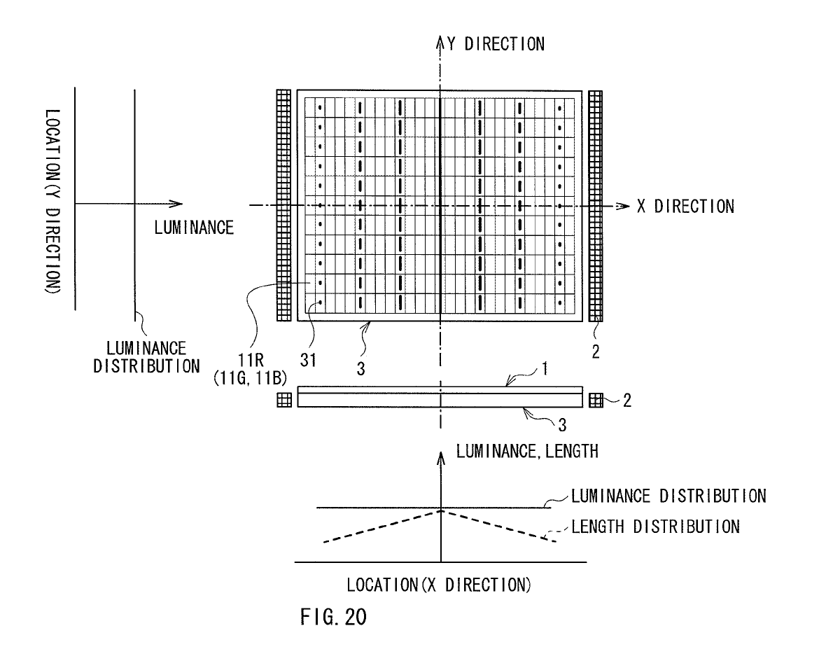

FIG. 21 illustrates a second exemplary correspondence relationship between an allocation pattern of perspective images and a layout pattern of the scattering regions 31, together with a luminance distribution and a depth distribution. In FIG. 21, as an allocation pattern of perspective images on the display section 1, a structure in which a pixel for red 11R, a pixel for green 11G, and a pixel for blue 11B are combined to form a triangular shape is adopted. The scattering region 31 is disposed at a portion corresponding to the vertex of the triangular shape according to the allocation pattern of the perspective images. With this configuration, the scattering regions 31 are discretely disposed in an X direction and a Y direction. FIG. 21 illustrates an example in which the luminance distribution is improved in such a manner that, in the case of such a layout pattern of the scattering regions 31, the height (depth) H1 is continuously decreased toward the two predetermined sides of the light guide plate 3 in the Y direction, and the height (depth) H1 is continuously increased toward the middle point between the two predetermined sides.

It is to be noted that, it is possible to vary, on a similar principle as in FIG. 19 and FIG. 20, the length of the scattering regions 31 which are laid out in a similar manner as in FIG. 21.

It is to be noted that, while FIG. 10 illustrates an exemplary case of two perspectives, the number of perspectives (the number of perspective images to be displayed) is not limited to two, and three or more perspective may be adopted. Further, the allocation pattern of the perspective images and the layout pattern of the scattering regions 31 are not limited to the examples illustrated in FIG. 10 and FIG. 21, and another pattern may be adopted. For example, an allocation pattern may be adopted in which a pixel for red 11R, a pixel for green 11G, and a pixel for blue 11B combined in an oblique direction are allocated as one pixel for displaying one perspective image. In this case, the scattering regions 31 are disposed in an oblique direction.

### [Effect]

As described above, with the display according to the present embodiment, since the scattering regions 31 and the total reflection area 32 are provided on the second internal reflection face 3B of the light guide plate 3, and the first illumination light of the first light source 2 and the second illumination light L10 of the second light source 7 may be selectively emitted to the outside of light guide plate 3, it is possible to allow the light guide plate 3 itself to have a function as a parallax barrier, equivalently. Thus, in comparison with stereoscopic displays using the known parallax barrier system, the number of components may be decreased to achieve space-saving.

In addition, with the display according to the present embodiment, since the structure is adopted in which the height (depth) H1 or the length of the scattering region 31 is varied according to the distance from a predetermined side on which the first light source 2 is disposed, and the height H1 or the length is decreased toward the predetermined side of the light guide plate 3, it is possible to optimize the luminance distribution of light emitted to the outside of the light guide plate 3. Thus, the quality of display at the time of three-dimensional display may be improved.

### Second Embodiment

Next, a display according to a second embodiment of the present disclosure is described. It is to be noted that, like or the same reference numerals are given to those components that are like or the same as the corresponding components of the display according to the above-mentioned first embodiment, and description thereof is appropriately omitted.

### [General Configuration of Display]

While the exemplary configuration in which the scattering regions 31 and the total reflection area 32 are provided on the second internal reflection face 3B side of the light guide plate 3 is described in the above-mentioned first embodiment, the scattering regions 31 and the total reflection area 32 may be provided on the first internal reflection face 3A side.

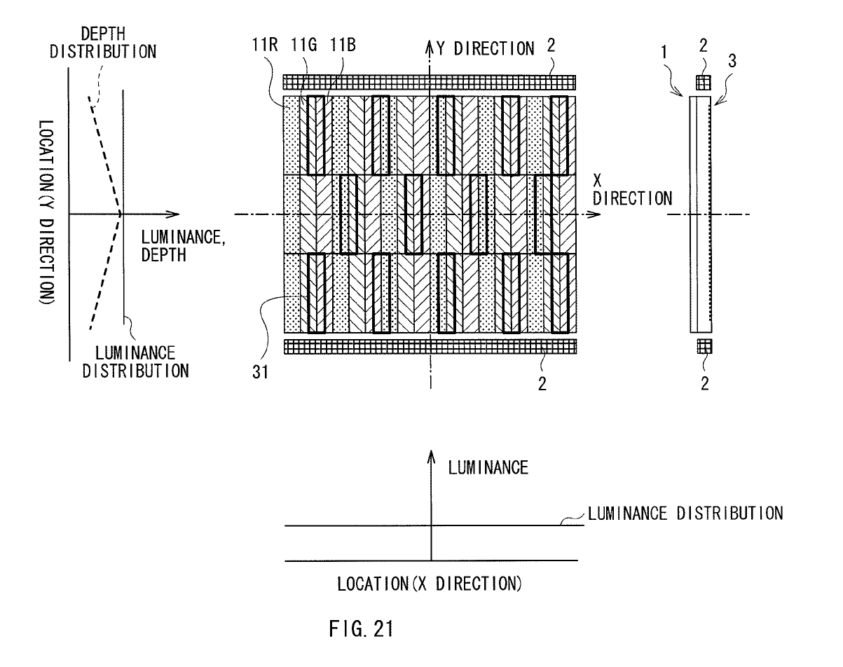

FIGS. 22A and 22B illustrate an exemplary configuration of the display according to the second embodiment of the present disclosure. This display is capable of, similarly to the display in FIG. 1, arbitrarily and selectively switching modes between a two-dimensional display mode and a three-dimensional display mode. FIG. 22A corresponds to a configuration in the three-dimensional display mode, and FIG. 22B corresponds to a configuration in the two-dimensional display mode. Also, FIGS. 22A and 22B schematically illustrate emitting states of light rays from the light source device in respective display modes.

The entirety of second internal reflection face 3B is minor finished so as to cause first illumination light L1 inputted at the incident angle θ1 satisfying a total reflection condition undergo internal total reflection. A first internal reflection face 3A has scattering regions 31 and a total reflection area 32. The total reflection area 32 and the scattering regions 31 are alternately provided on the first internal reflection face 3A to form a structure of, for example, a striped shape corresponding to a parallax barrier. In other words, as described later, in a three-dimensional display mode, the scattering region 31 and the total reflection area 32 function as an opening part (slit part) and a blocking part as a parallax barrier, respectively.

The total reflection area 32 causes the first illumination light L1 inputted at the incident angle θ1 satisfying the total reflection condition undergo internal total reflection (causes the first illumination light L1 inputted at the incident angle θ1 greater than a predetermined critical angle α undergo internal total reflection). The scattering region 31 emits, of incident light rays L2, at least a part of the light beam L2 inputted at an angle corresponding to the incident angle θ1 satisfying a predetermined total reflection condition in the total reflection area 32 to the outside (emits at least a part of the light beam L2 inputted at an angle corresponding to the incident angle θ1 greater than the predetermined critical angle α to the outside). In the scattering region 31, another part of the incident light rays L2 undergoes internal reflection.

To perform the spatial separation of a plurality of perspective images displayed on a display section 1 in the display illustrated in FIG. 22A, a pixel section of the display section 1 and the scattering region 31 of the light guide plate 3 need to be oppositely disposed with a predetermined distance d maintained therebetween. In FIG. 22A, a spacer 8 is disposed between the display section 1 and the light guide plate 3. The spacer 8 may be any material as long as it is colorless and transparent and causes little scattering, and for example, a PMMA may be used. The spacer 8 may be provided so as to cover all of the surface of the back side of the display section 1 and the surface of the light guide plate 3, or may be partially provided only as needed to maintain the distance d.

### [Detailed Configuration Example of Scattering Region 31]

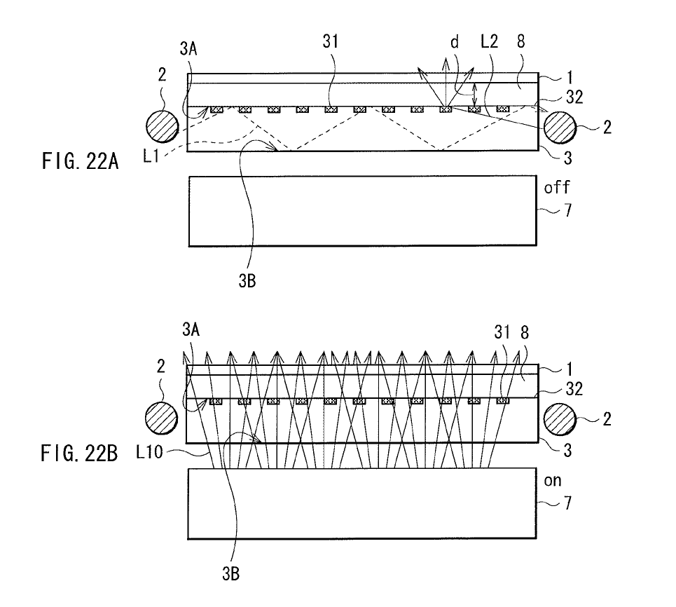

FIG. 23A illustrates a first exemplary configuration of the surface of the light guide plate 3. FIG. 23B schematically illustrates a reflection mode and a scattering mode of light rays on the surface of the light guide plate 3 illustrated in FIG. 23A. The first exemplary configuration is an exemplary configuration in which the scattering region 31 is a scattering region 31A recessed with respect to the total reflection area 32. Such a recessed scattering region 31A may be formed by, for example, performing laser processing on a portion corresponding to the scattering region 31A after the surface of the light guide plate 3 is mirror finished. In the case where such a recessed scattering region 31A is adopted, of incident light rays, at least a part of the light beam inputted at an angle corresponding to the incident angle θ1 satisfying a predetermined total reflection condition in the total reflection area 32 does not satisfy the total reflection condition at a recessed side face portion 33, and is emitted to the outside.

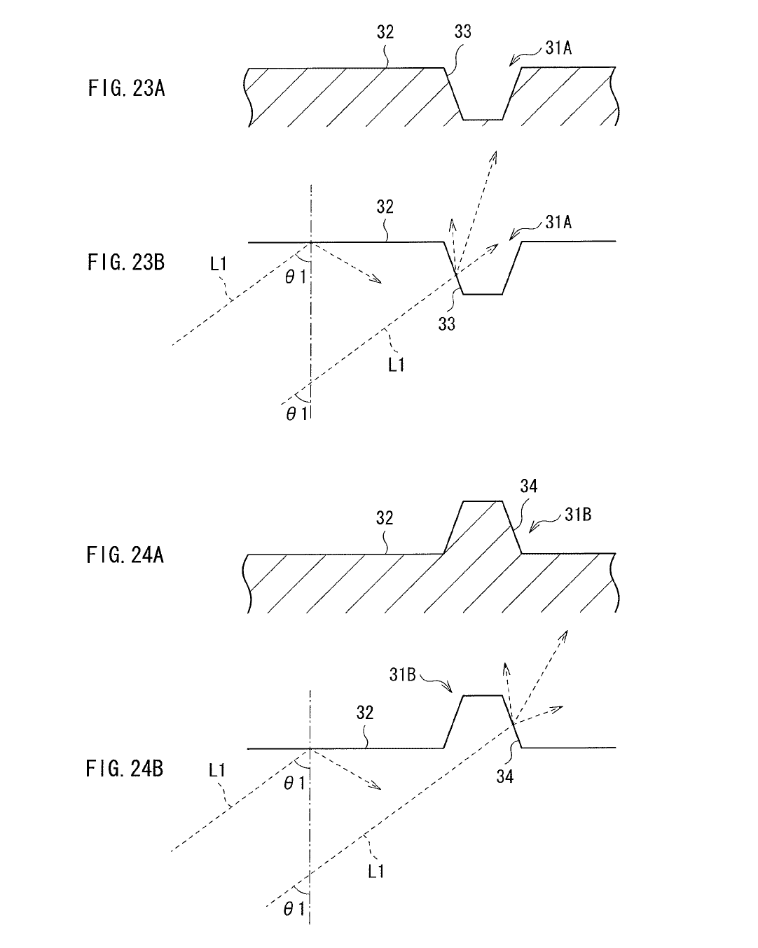

FIG. 24A illustrates a second exemplary configuration of the surface of the light guide plate 3. FIG. 24B schematically illustrates a reflection mode and a scattering mode of light rays on the surface of the light guide plate 3 illustrated in FIG. 24A. The second exemplary configuration is an exemplary configuration in which the scattering region 31 is a scattering region 31B raised with respect to the total reflection area 32. Such a raised form may be formed by performing mold processing on the surface of the light guide plate 3 with use of a metal mold, for example. In this case, a portion corresponding to the total reflection area 32 is mirror finished by the surface of the metal mold. In the case where such a raised scattering region 31B is adopted, of incident light rays, at least a part of the light beam inputted at an angle corresponding to the incident angle θ1 satisfying a predetermined total reflection condition in the total reflection area 32 does not satisfy the total reflection condition at a raised side face portion 34, and is emitted to the outside.

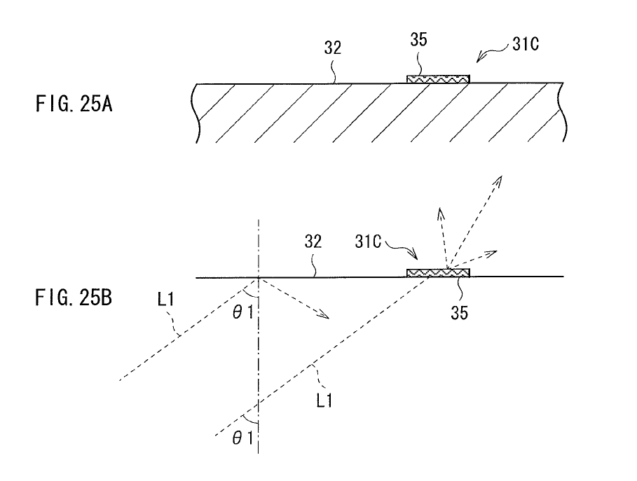

FIG. 25A illustrates a third exemplary configuration of the surface of the light guide plate 3. FIG. 25B schematically illustrates a reflection mode and a scattering mode of light rays on the surface of the light guide plate 3 illustrated in FIG. 25A. In the exemplary configurations in FIG. 23A and FIG. 24A, the surface of the light guide plate 3 is subjected to surface treatment to form the scattering region 31 having a shape different from that of the total reflection area 32. In contrast, a scattering region 31C of the exemplary configuration in FIG. 25A is formed, not by surface treatment, but by disposing a light scattering member 35 on the surface of the light guide plate 3 corresponding to the first internal reflection face 3A. As the light diffusion member 35, a member having a refractive index greater than that of the light guide plate 3 such as a PET resin having a refractive index of approximately 1.57, for example, may be used. For example, a diffusion sheet made of a PET resin is bonded to the surface of the light guide plate 3 with use of an acrylic adhesive to form the scattering region 31C. In the case where such a scattering region 31C configured by disposing the light diffusion member 35 is adopted, of incident light rays, at least a part of the light beam inputted at an angle corresponding to the incident angle θ1 satisfying a predetermined total reflection condition in the total reflection area 32 does not satisfy the total reflection condition due to a variation of refractive index at the light diffusion member 35, and is emitted to the outside.

The configuration of the scattering region 31 is not limited to the above-mentioned exemplary configuration, and other configurations may be adopted. For example, the portion corresponding to the scattering region 31 may be formed by sandblast processing, paint processing or the like on the surface of the light guide plate 3.

### [Basic Operation of Display]

In the display, when a display is performed in the three-dimensional display mode (FIG. 22A), an image is displayed on the display section 1 based on three-dimensional image data, and the entirety of the second light source 7 is set to an off (light-off) state. The first light sources 2 disposed on the sides of the light guide plate 3 are set to an on (light-on) state. In this state, first illumination light L1 from the first light source 2 is caused to repeatedly undergo internal total reflection between the total reflection area 32 of the first internal reflection face 3A and the second internal reflection face 3B in the light guide plate 3. Then, the first illumination light L1 is guided from one side on which the first light source 2 is disposed to the other side opposite thereto, and emitted from the other side. On the other hand, of light rays L2 incident on the scattering region 31 of the first internal reflection face 3A in the light guide plate 3, a part of the light beam L2 which does not satisfy the total reflection condition is emitted from the scattering region 31 to the outside. While in the scattering region 31, another part of the light beam L2 is caused to undergo the internal reflection, such light rays are emitted to the outside through the second internal reflection face 3B of the light guide plate 3, making no contribution to image display. As a result, in the light guide plate 3, light rays are emitted only from the scattering region 31 of the first internal reflection face 3A. In other words, it is possible to allow the surface of the light guide plate 3 to, equivalently, function as a parallax barrier in which the scattering region 31 serves as an opening part (slit part) and the total reflection area 32 serves as a blocking part. With this configuration, a three-dimensional display is performed, equivalently, by a parallax barrier system in which a parallax barrier is disposed on the back side of the display section 1.

On the other hand, when a display is performed in the two-dimensional display mode (FIG. 22B), an image is displayed on the display section 1 based on two-dimensional image data, and the entirety of the second light source 7 is set to an on (light-on) state. The first light sources 2 disposed on the sides of the light guide plate 3 are set to a light-off state, for example. In this state, second illumination light L10 from the second light source 7 enters the light guide plate 3 in a substantially vertical state through the second internal reflection face 3B. Therefore, the incident angle of the light beam does not satisfy the total reflection condition in the total reflection area 32, and the light beam is emitted to the outside not only from the scattering region 31, but also from the total reflection area 32. As a result, in the light guide plate 3, light rays are emitted from the entirety of the first internal reflection face 3A. In other words, the light guide plate 3 functions as a planar light source similar to typical backlights. Thus, a two-dimensional display is equivalently performed by a backlight system in which a typical backlight is disposed on the back side of the display section 1.

It is to be noted that, when a display is performed in the two-dimensional display mode, it is possible to set the first light sources 2 disposed on the sides of the light guide plate 3 to an on (light-on) state, together with the second light source 7. In addition, when a display is performed in the two-dimensional display mode, the first light sources 2 may be switched between a light-off state and a light-on state, as necessary. With this configuration, for example, in the case where difference in a luminance distribution is caused in the scattering region 31 and the total reflection area 32 when only the second light source 7 is turned on, it is possible to optimize the luminance distribution over the entire face by appropriately adjusting the light-on state of the first light sources 2 (by performing an on-off control, or by adjusting the amount of lighting).

### [Correspondence Relationship Between Allocation Pattern of Perspective Images and Layout Pattern of Scattering Region 31]

In the display, when a display is performed in the three-dimensional display mode, a plurality of perspective images are allocated to respective pixels in a predetermined allocation pattern and displayed on the display section 1. A plurality of the scattering regions 31 of the light guide plate 3 are provided in a predetermined layout pattern corresponding to the predetermined allocation pattern.

(A) of FIG. 26 illustrates an exemplary correspondence relationship between the layout pattern of the scattering regions 31 and the allocation pattern of perspective images when two perspective images (first and second perspective images) are allocated to respective pixels of the display section 1 in the case where the general configuration of FIG. 22A and the pixel structure of FIG. 9 are adopted. (B) of FIG. 26 is a cross sectional view taken along A-A′ portion in (A) of FIG. 26. (B) of FIG. 26 schematically illustrates a separating state of two perspective images. In this example, one unit pixel of a 2D color display is allocated as one pixel for displaying one perspective image. In addition, pixels are allocated so that the first perspective image and the second perspective image are alternately displayed in a horizontal direction. Therefore, two unit pixels of the 2D color display combined in a horizontal direction serves as one unit image (one stereoscopic pixel) in a three-dimensional display. As illustrated in (B) of FIG. 26, in the state where a first perspective image reaches only a right eye 10R of a viewer and a second perspective image reaches only a left eye 10L of the viewer, stereoscopic viewing is performed. In this example, the position of the scattering region 31 in a horizontal direction is such that the scattering region 31 is disposed so as to be positioned at the substantially center portion of one unit image in a three-dimensional display. Similarly to the above-mentioned case of (A) and (B) of FIG. 10, a width D1 of the scattering region 31 in a horizontal direction is a size which has a predetermined relationship with a width D2 of one pixel for illustrating one perspective image.

Also in the present embodiment, a height (depth) H1 with respect to the surface of the light guide plate of the scattering region 31 may be optimized in a similar way as the above-mentioned examples illustrated in FIG. 13 to FIG. 15.

In addition, the length of the scattering region 31 may be optimized in a similar way as the above-mentioned examples illustrated in FIG. 19 to FIG. 20.

### [Effect]

As described above, with the display according to the present embodiment, since the scattering regions 31 and the total reflection area 32 are provided on the first internal reflection face 3A of the light guide plate 3, and the first illumination light of the first light source 2 and the second illumination light L10 of the second light source 7 may be selectively emitted to the outside of light guide plate 3, it is possible to allow the light guide plate 3 itself to have a function as a parallax barrier, equivalently. Thus, in comparison with stereoscopic displays using the known parallax barrier system, the number of components may be decreased to achieve space-saving.

In addition, similarly to the above-mentioned first embodiment, it is possible to optimize the luminance distribution of light emitted to the outside of the light guide plate 3. Thus, the quality of display at the time of three-dimensional display may be improved.

### Third Embodiment

Next, a display according to a third embodiment of the present disclosure is described. It is to be noted that, like or the same reference numerals are given to those components that are like or the same as the corresponding components of the display according to the above-mentioned first embodiment or second embodiment, and description thereof is appropriately omitted.

### [General Configuration of Display]

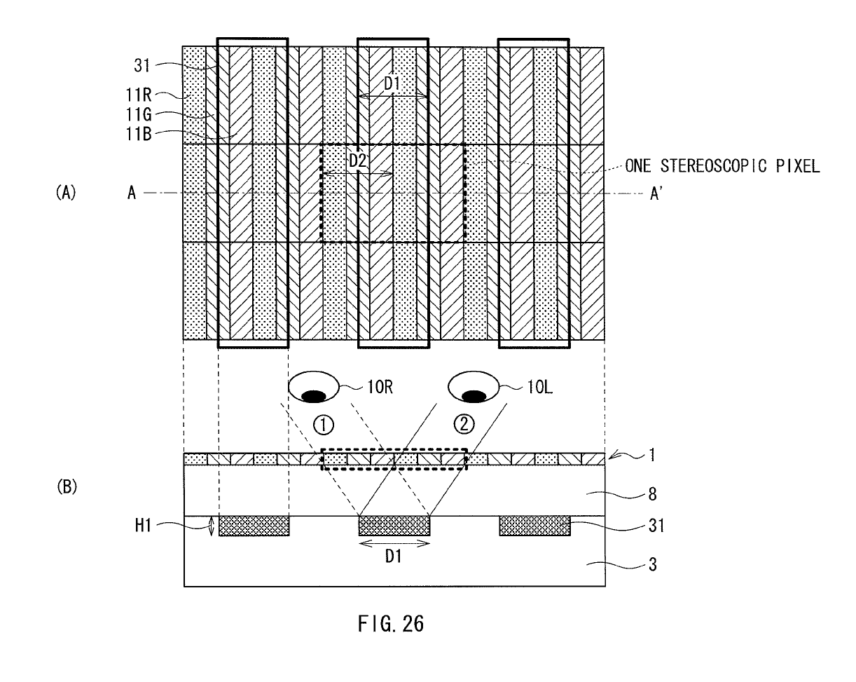

FIGS. 27A and 27B illustrate an exemplary configuration of a display according to the third embodiment of the present disclosure. This display includes an electronic paper 4 in place of the second light source 7 of the display of FIGS. 22A and 22B.

This display is capable of arbitrarily and selectively switching modes between a two-dimensional (2D) display mode over the entire screen and a three-dimensional (3D) display mode over the entire screen. FIG. 27A corresponds to a configuration in the three-dimensional display mode, and FIG. 27B corresponds to a configuration in the two-dimensional display mode. Also, FIGS. 27A and 27B schematically illustrate emitting states of light rays from the light source device in respective display modes.

The electronic paper 4 is disposed to face a light guide plate 3 on the side on which a second internal reflection face 3B is formed. The electronic paper 4 is an optical device capable of selectively switching modes of action on incident light rays between a light absorption mode and a scattering-reflection mode. The electronic paper 4 is configured of a particle movement-type display using an electrophoresis system or a quick-response liquid powder system, for example. In the particle movement-type display, positively charged black particles, for example, and negatively charged white particles, for example, are dispersed between a pair of substrates facing each other, and the particles are caused to move in response to the voltage applied between the substrates in order to perform black display or white display. In particular, in the electrophoresis system, particles are dispersed in solution, and in the quick-response liquid powder system, particles are dispersed in gas. The above-mentioned light absorption mode is established by setting the entirety of a display face 41 of the electronic paper 4 to a black display state as illustrated in FIG. 27A, whereas the above-mentioned scattering-reflection mode is established by setting the entirety of the display face 41 of the electronic paper 4 to a white display state as illustrated in FIG. 27B. The electronic paper 4 sets the action on incident light rays to the light absorption mode in the case where a plurality of perspective images based on three-dimensional image data are displayed on the display section 1 (in a three-dimensional display mode). Also, the electronic paper 4 sets the action on incident light rays to the scattering-reflection mode in the case where an image based on two-dimensional image data is displayed on the display section 1 (in a two-dimensional display mode).

To perform the spatial separation of a plurality of perspective images displayed on the display section 1 in the display illustrated in FIGS. 27A and 27B, a pixel section of the display section 1 and the scattering region 31 of the light guide plate 3 need to be oppositely disposed with a predetermined distance d maintained therebetween. While in FIGS. 27A and 27B, the space between the display section 1 and the light guide plate 3 is an air space, a spacer 8 may be disposed between the display section 1 and the light guide plate 3 to maintain the predetermined distance d, similarly to the display illustrated in FIGS. 22A and 22B.

### [Operation of Display]

In the display, when a display is performed in the three-dimensional display mode (FIG. 27A), an image is displayed on the display section 1 based on three-dimensional image data, and the entirety of the display face 41 of the electronic paper 4 is set to the black display state (light absorption mode). In this state, first illumination light L1 from the first light source 2 is caused to repeatedly undergo internal total reflection between the total reflection area 32 of the first internal reflection face 3A and the second internal reflection face 3B in the light guide plate 3. Then, the first illumination light L1 is guided from one side on which the first light source 2 is disposed to the other side opposite thereto, and emitted from the other side. On the other hand, of light rays L2 incident on the scattering region 31 of the first internal reflection face 3A in the light guide plate 3, a part of the light beam L2 which does not satisfy a total reflection condition is emitted from the scattering region 31 to the outside. While in the scattering region 31, light rays L3 of another part undergoes the internal reflection, such light rays L3 enter the display face 41 of the electronic paper 4 through the second internal reflection face 3B of the light guide plate 3. At this time, since the entirety of the display face 41 of the electronic paper 4 is in the black display state, the light beam L3 is absorbed at the display face 41. As a result, in the light guide plate 3, light rays are emitted only from the scattering region 31 of the first internal reflection face 3A. In other words, it is possible to allow the surface of the light guide plate 3 to, equivalently, function as a parallax barrier in which the scattering region 31 serves as an opening part (slit part) and the total reflection area 32 serves as a blocking part. With this configuration, a three-dimensional display is performed, equivalently, by a parallax barrier system in which a parallax barrier is disposed on the back side of the display section 1.

On the other hand, when a display is performed in the two-dimensional display mode (FIG. 27B), an image is displayed on the display section 1 based on two-dimensional image data, and the entirety of the display face 41 of the electronic paper 4 is set to the white display state (scattering-reflection mode). In this state, first illumination light L1 from the first light source 2 is caused to repeatedly undergo internal total reflection between the total reflection area 32 of the first internal reflection face 3A and the second internal reflection face 3B in the light guide plate 3. Then, the first illumination light L1 is guided from one side on which the first light source 2 is disposed to the other side opposite thereto, and emitted from the other side. On the other hand, of light rays L2 incident on the scattering region 31 of the first internal reflection face 3A in the light guide plate 3, a part of the light beam L2 which does not satisfy the total reflection condition is emitted from the scattering region 31 to the outside. While in the scattering region 31, light rays L3 of another part undergo the internal reflection, such light rays L3 enter the display face 41 of the electronic paper 4 through the second internal reflection face 3B of the light guide plate 3. At this time, since the entirety of the display face 41 of the electronic paper 4 is in the white display state, the light beam L3 is reflected in a scattered manner at the display face 41. The light beam reflected in a scattered manner again enters the light guide plate 3 through the second internal reflection face 3B, and since the incident angle of the light beam does not satisfy the total reflection condition in the total reflection area 32, the light beam is emitted not only from the scattering region 31, but also from the total reflection area 32 to the outside. As a result, in the light guide plate 3, light rays are emitted from the entirety of the first internal reflection face 3A. In other words, the light guide plate 3 functions as a planar light source similar to typical backlights. Thus, a two-dimensional display is equivalently performed by a backlight system in which a typical backlight is disposed on the back side of the display section 1.

### [Effect]

As described above, with the display according to the present embodiment, since the total reflection area 32 and the scattering regions 31 are provided on the first internal reflection face 3A of the light guide plate 3, it is possible to allow the light guide plate 3 itself to have a function as a parallax barrier, equivalently. Thus, in comparison with stereoscopic displays using the known parallax barrier system, the number of components may be decreased to achieve space-saving. In addition, it is possible to easily switch modes between the two-dimensional display mode and the three-dimensional display mode by only switching the display state of the electronic paper 4.

### Fourth Embodiment

Next, a display according to a fourth embodiment of the present disclosure is described. It is to be noted that, like or the same reference numerals are given to those components that are like or the same as the corresponding components of the display according to the above-mentioned first to third embodiments, and description thereof is appropriately omitted.

### [General Configuration of Display]

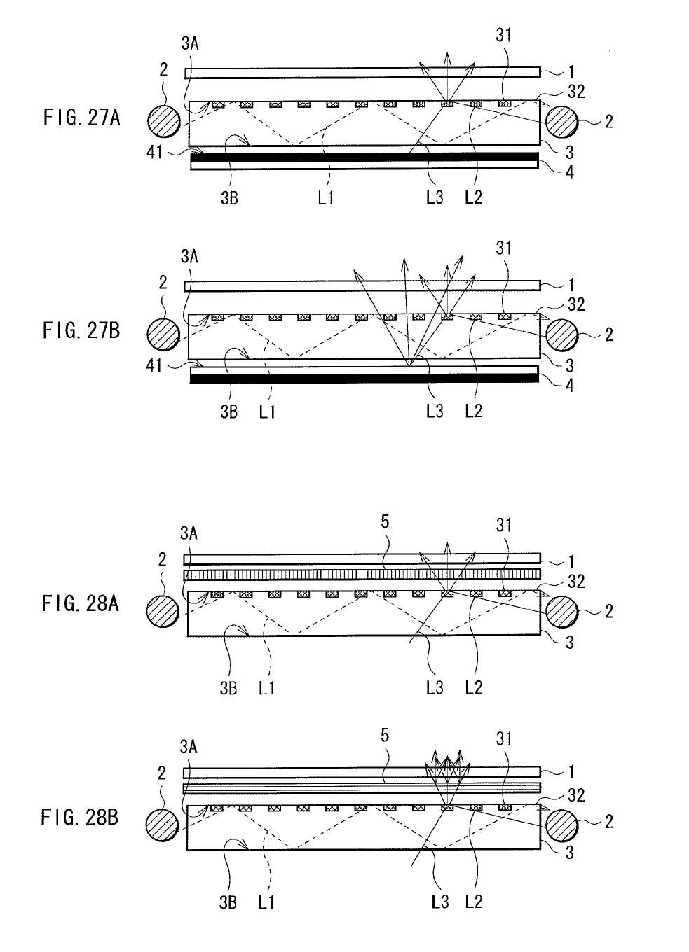

FIGS. 28A and 28B illustrate an exemplary configuration of a display according to a fourth embodiment of the present disclosure. Similarly to the display in FIGS. 27A and 27 B, this display is capable of arbitrarily and selectively switching modes between a two-dimensional display mode and a three-dimensional display mode. FIG. 28A corresponds to a configuration in the three-dimensional display mode, and FIG. 28B corresponds to a configuration in the two-dimensional display mode. Also, FIGS. 28A and 28B schematically illustrate emitting states of light rays from the light source device in respective display modes.

In this display, a light source device includes a polymer diffusion plate 5 in place of the electronic paper 4 of the display in FIGS. 27A and 27B. Other configuration of this display is similar to the display in FIGS. 27A and 27B. The polymer diffusion plate 5 is configured of a polymer-dispersed liquid crystal. The polymer diffusion plate 5 is disposed to face a light guide plate 3 on the side on which a first internal reflection face 3A is formed. The polymer diffusion plate 5 is an optical device capable of selectively switching modes of action on incident light rays between a transparent mode and a diffusion-transmission mode, according to a voltage to be applied to a liquid crystal layer.

### [Basic Operation of Display]

In the display, when a display is performed in the three-dimensional display mode (FIG. 28A), an image is displayed on a display section 1 based on three-dimensional image data, and the entirety of the polymer diffusion plate 5 is set to the transparent mode. In this state, first illumination light L1 from a first light source 2 is caused to repeatedly undergo internal total reflection between a total reflection area 32 of the first internal reflection face 3A and a second internal reflection face 3B in the light guide plate 3. Then, the first illumination light L1 is guided from one side on which the first light source 2 is disposed to the other side opposite thereto, and emitted from the other side. On the other hand, of light rays L2 incident on the scattering region 31 of the first internal reflection face 3A in the light guide plate 3, a part of the light rays L2 which do not satisfy a total reflection condition is emitted from the scattering region 31 to the outside. The light rays emitted to the outside through the scattering region 31 enter the polymer diffusion plate 5, and since the entirety of the polymer diffusion plate 5 is in the transparent mode, the light rays pass through the polymer diffusion plate 5 and enters the display section 1 with the emission angle from the scattering region 31 being maintained. While in the scattering region 31, light rays L3 of another part are caused to undergo the internal reflection, such light rays L3 are emitted to the outside through the second internal reflection face 3B of the light guide plate 3, making no contribution to image display. As a result, in the light guide plate 3, light rays are emitted only from the scattering region 31 of the first internal reflection face 3A. In other words, it is possible to allow the surface of the light guide plate 3 to, equivalently, function as a parallax barrier in which the scattering region 31 serves as an opening part (slit part) and the total reflection area 32 serves as a blocking part. With this configuration, a three-dimensional display is performed, equivalently, by a parallax barrier system in which a parallax barrier is disposed on the back side of the display section 1.

On the other hand, when a display is performed in the two-dimensional display mode (FIG. 28B), an image is displayed on a display section 1 based on two-dimensional image data, and the entirety of the polymer diffusion plate 5 is set to the diffusion-transmission mode. In this state, first illumination light L1 from the first light source 2 is caused to repeatedly undergo internal total reflection between the total reflection area 32 of the first internal reflection face 3A and the second internal reflection face 3B in the light guide plate 3. Then, the first illumination light L1 is guided from one side on which the first light source 2 is disposed to the other side opposite thereto, and emitted from the other side. On the other hand, of light rays L2 incident on the scattering region 31 of the first internal reflection face 3A in the light guide plate 3, a part of the light beam L2 which do not satisfy the total reflection condition is emitted from the scattering region 31 to the outside. At this time, the light beam emitted to the outside through the scattering region 31 enters the polymer diffusion plate 5, and since the entirety of the polymer diffusion plate 5 is in the diffusion-transmission mode, the light beam incident on the display section 1 becomes a diffused state by the polymer diffusion plate 5 over the entire face. As a result, a light source device as a whole functions as a planar light source similar to typical backlights. Thus, a two-dimensional display is equivalently performed by a backlight system in which a typical backlight is disposed on the back side of the display section 1.

### Other Embodiments

The technology of the present disclosure is not limited to the above-mentioned embodiments, and various modifications may be made.

For example, while, in the above-mentioned embodiments, the exemplary configurations are described in which the scattering regions 31 and the total reflection area 32 are provided on only one of the first internal reflection face 3A and the second internal reflection face 3B in the light guide plate 3, the scattering regions 31 and the total reflection area 32 may be provided on both of the first internal reflection face 3A and the second internal reflection face 3B.

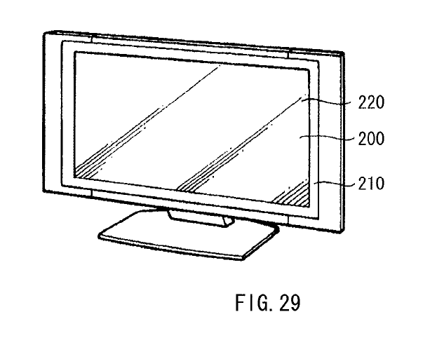

In addition, for example, any of the displays according to the respective embodiments may be applied to various kinds of electronic unit with a display function. FIG. 29 shows an external configuration of a television unit as an example of such an electronic unit. This television unit includes an image display screen section 200 having a front panel 210 and a filter glass 220.

It is possible to achieve at least the following configurations from the above-described exemplary embodiments and the modifications of the disclosure.

(1) A display including:

a display section performing image display; and

a light source device including a light guide plate and one or more first light sources, and emitting light for the image display toward the display section, the light guide plate having a first internal reflection face and a second internal reflection face which face each other and having one or more side faces, and the first light sources being disposed to face the respective side faces of the light guide plate and to apply first illumination light through the side face of the light guide plate into the light guide plate,

wherein one or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.

(2) The display according to (1), further including a second light source disposed to face a surface, of the light guide plate, corresponding to the second internal reflection face, the second light source externally applying the second illumination light to the second internal reflection face.

(3) The display according to (2), wherein

the display section is configured to selectively switch images to be displayed between a plurality of perspective images based on three-dimensional image data and an image based on two-dimensional image data, and

the second light source is controlled to stay in a light-off state when the plurality of perspective images are displayed on the display section, and controlled to stay in a light-on state when the image based on the two-dimensional image data is displayed on the display section.

(4) The display according to (3), wherein the first light source is controlled to stay in a light-on state when the plurality of perspective images are displayed on the display section, and controlled to stay in either a light-off state or the light-on state when the image based on the two-dimensional image data is displayed on the display section.

(5) The display according to (1), further including an optical device disposed to face a surface, of the light guide plate, corresponding to the second internal reflection face, and allowed to selectively switch modes of action on incident light rays between a light absorption mode and a scattering-reflection mode.

(6) The display according to (1), further including an optical device disposed to face a surface, of the light guide plate, corresponding to the first internal reflection face, and allowed to selectively switch modes of action on incident light rays between a transparent mode and a diffusion-transmission mode.

(7) A display including:

a display section; and

a light source device including a light guide plate, one or more first light sources, and a second light source, the light guide plate having a first face and a second face which face each other and having one or more side faces, the first light sources being disposed to face the respective side faces of the light guide plate, the second light source being disposed to face a surface, of the light guide plate, corresponding to the second face, the second light source being controlled to stay in a light-off state when the display section is in a 3D mode, and controlled to stay in a light-on state when the display section is in a 2D mode,

wherein one or both of the first and second faces each have a plurality of scattering regions, the scattering regions being configured to vary in form according to a distance from a side face of the light guide plate.

(8) A light source device including:

a light guide plate having a first internal reflection face and a second internal reflection face which face each other, and having one or more side faces; and

one or more first light sources disposed to face the respective side faces of the light guide plate and to apply first illumination light through the side faces of the light guide plate into the light guide plate,

wherein one or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.

(9) The light source device according to (8), wherein

the plurality of scattering regions each has a form with a dimension of height or length, and

one or both of the height and the length of each of the plurality of scattering regions are decreased toward the predetermined side face.

(10) The light source device according to (8) or (9), wherein the light guide plate has, as the side faces, a first side face and a second side face which face each other in a first direction, and a third side face and a fourth side face which face each other in a second direction orthogonal to the first direction.

(11) The light source device according to (10), wherein

the first light sources are disposed to face the first side face and the second side face, respectively, and

one or both of the height and the length of each of the plurality of scattering regions are decreased toward the first side face and the second side face, and are increased toward a middle point between the first side face and the second side face.

(12) The light source device according to (10), wherein

the first light sources are disposed to face the third side face and the fourth side face, respectively, and

one or both of the height and the length of each of the plurality of scattering regions are decreased toward the third side face and the fourth side face, and are increased toward a middle point between the third side face and the fourth side face.

(13) The light source device according to (10), wherein the plurality of scattering regions are provided to extend in the first direction between the first side face and the second side face, and are arranged side by side in the second direction.

(14) The light source device according to any one of (8) to (13), wherein the plurality of scattering regions are configured to each have a form with a dimension of height and to continuously vary in height according to the distance from the side face of the light guide plate.

(15) The light source device according to any one of (8) to (13), wherein the plurality of scattering regions are configured to each have a form with a dimension of height and to vary step by step in height according to the distance from the side face of the light guide plate.

(16) The light source device according to any one of (8) to (15), further including a second light source disposed to face a surface, of the light guide plate, corresponding to the second internal reflection face, the second light source externally applying the second illumination light to the second internal reflection face.

(17) An electronic unit including a display, the display including:

a display section performing an image display; and

a light source device including a light guide plate and one or more first light sources, and emitting light for the image display toward the display section, the light guide plate having a first internal reflection face and a second internal reflection face which face each other and having one or more side faces, and the first light sources being disposed to face the respective side faces of the light guide plate, and to apply first illumination light through the side face of the light guide plate into the light guide plate,

wherein one or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.

The present disclosure contains subject matter related to that disclosed in Japanese Priority Patent Application JP 2011-084733 filed in the Japan Patent Office on Apr. 6, 2011, and Japanese Priority Patent Application JP 2011-214870 filed in the Japan Patent Office on Sep. 29, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display comprising:
a display section performing image display; and
a light source device including a light guide plate and one or more first light sources, and emitting light for the image display toward the display section, the light guide plate having a first internal reflection face and a second internal reflection face which face each other and having one or more side faces, and the first light sources being disposed to face the respective side faces of the light guide plate and to apply first illumination light through the side face of the light guide plate into the light guide plate,
wherein one or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.

2. The display according to claim 1, further comprising a second light source disposed to face a surface, of the light guide plate, corresponding to the second internal reflection face, the second light source externally applying the second illumination light to the second internal reflection face.

3. The display according to claim 2, wherein
the display section is configured to selectively switch images to be displayed between a plurality of perspective images based on three-dimensional image data and an image based on two-dimensional image data, and
the second light source is controlled to stay in a light-off state when the plurality of perspective images are displayed on the display section, and controlled to stay in a light-on state when the image based on the two-dimensional image data is displayed on the display section.

4. The display according to claim 3, wherein the first light source is controlled to stay in a light-on state when the plurality of perspective images are displayed on the display section, and controlled to stay in either a light-off state or the light-on state when the image based on the two-dimensional image data is displayed on the display section.

5. The display according to claim 1, further comprising an optical device disposed to face a surface, of the light guide plate, corresponding to the second internal reflection face, and allowed to selectively switch modes of action on incident light rays between a light absorption mode and a scattering-reflection mode.

6. The display according to claim 1, further comprising an optical device disposed to face a surface, of the light guide plate, corresponding to the first internal reflection face, and allowed to selectively switch modes of action on incident light rays between a transparent mode and a diffusion-transmission mode.

7. A display comprising:
a display section; and
a light source device including a light guide plate, one or more first light sources, and a second light source, the light guide plate having a first face and a second face which face each other and having one or more side faces, the first light sources being disposed to face the respective side faces of the light guide plate, the second light source being disposed to face a surface, of the light guide plate, corresponding to the second face, the second light source being controlled to stay in a light-off state when the display section is in a 3D mode, and controlled to stay in a light-on state when the display section is in a 2D mode,
wherein one or both of the first and second faces each have a plurality of scattering regions, the scattering regions being configured to vary in form according to a distance from a side face of the light guide plate.

8. A light source device comprising:
a light guide plate having a first internal reflection face and a second internal reflection face which face each other, and having one or more side faces; and
one or more first light sources disposed to face the respective side faces of the light guide plate and to apply first illumination light through the side faces of the light guide plate into the light guide plate,
wherein one or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.

9. The light source device according to claim 8, wherein
the plurality of scattering regions each has a form with a dimension of height or length, and
one or both of the height and the length of each of the plurality of scattering regions are decreased toward the predetermined side face.

10. The light source device according to claim 8, wherein the light guide plate has, as the side faces, a first side face and a second side face which face each other in a first direction, and a third side face and a fourth side face which face each other in a second direction orthogonal to the first direction.

11. The light source device according to claim 10, wherein
the first light sources are disposed to face the first side face and the second side face, respectively, and
one or both of the height and the length of each of the plurality of scattering regions are decreased toward the first side face and the second side face, and are increased toward a middle point between the first side face and the second side face.

12. The light source device according to claim 10, wherein
the first light sources are disposed to face the third side face and the fourth side face, respectively, and
one or both of the height and the length of each of the plurality of scattering regions are decreased toward the third side face and the fourth side face, and are increased toward a middle point between the third side face and the fourth side face.

13. The light source device according to claim 10, wherein the plurality of scattering regions are provided to extend in the first direction between the first side face and the second side face, and are arranged side by side in the second direction.

14. The light source device according to claim 8, wherein the plurality of scattering regions are configured to each have a form with a dimension of height and to continuously vary in height according to the distance from the side face of the light guide plate.

15. The light source device according to claim 8, wherein the plurality of scattering regions are configured to each have a form with a dimension of height and to vary step by step in height according to the distance from the side face of the light guide plate.

16. The light source device according to claim 8, further comprising a second light source disposed to face a surface, of the light guide plate, corresponding to the second internal reflection face, the second light source externally applying the second illumination light to the second internal reflection face.

17. An electronic unit including a display, the display comprising:
a display section performing an image display; and
a light source device including a light guide plate and one or more first light sources, and emitting light for the image display toward the display section, the light guide plate having a first internal reflection face and a second internal reflection face which face each other and having one or more side faces, and the first light sources being disposed to face the respective side faces of the light guide plate, and to apply first illumination light through the side face of the light guide plate into the light guide plate,
wherein one or both of the first and second internal reflection faces each have a plurality of scattering regions, the scattering regions being configured to vary in form according to a distance from a side face of the light guide plate and allowing the first illumination light from the first light source to be scattered and to exit from the first internal reflection face to outside of the light guide plate.
